(19) United States
(12) Patent Application Publication
(10) Pub. No.: US 2026/0245057 A1
(43) Pub. Date: Aug. 20, 2026

(54) Multi-Form Currency and Banking System Integrating Multi-Domain Distributed Ledgers, AI-Driven Risk Control, Brand-Franchise Expansion, and Co-Ownership Tokens

(71) Applicant: FURONG BEI, San Gabriel, CA (US)

(72) Inventor: FURONG BEI, San Gabriel, CA (US)

(21) Appl. No.: 19/056,745

(22) Filed: Feb. 19, 2025

(51) Int. Cl. G06Q 20/06; G06Q 30/0273; G06Q 40/02; G06Q 40/03; G06Q 40/04; G06Q 40/06

(52) U.S. Cl. CPC G06Q 20/065; G06Q 30/0275; G06Q 40/024; G06Q 40/0325; G06Q 40/033; G06Q 40/04; G06Q 40/06; G06Q 2220/00

(57) ABSTRACT

A domain-routed distributed transaction computing system is disclosed. A domain identifier is canonicalized and resolved against a domain namespace registry to retrieve a route object identifying a ledger route, ledger-resident contract interface, compliance metadata, gateway policy, and settlement-evidence schema. A selected versioned compliance block is executed against a transaction request, and an AI-driven risk control module generates a risk indicator converted into a machine-readable enforcement directive. A protocol-level gate prevents signing, ledger submission, cross-ledger bridging, or external payment-network transmission unless the compliance result and enforcement directive satisfy the route object's gateway policy. When permitted, a cross-ledger gateway or external payment-network adapter routes the request and returns gateway execution data. An evidence recorder stores an auditable settlement evidence record linking the domain identifier, route object, compliance block, risk indicator, enforcement directive, gateway execution data, settlement state, and bounded recovery state.

### TECHNICAL FIELD

This disclosure relates to distributed computing systems, identity-routed financial computing, domain-based namespaces, programmable ledger interfaces, multi-ledger settlement, risk-gated transaction routing, and compliance-enforced value-transfer networks.

More particularly, the disclosure describes a domain-routed sub-bank computing architecture in which a domain identifier functions as a deterministic namespace root for binding users, institutions, sub-bank smart contracts, ledger instances, compliance packages, risk controls, collateral records, and settlement evidence into an auditable computing pipeline.

The architecture is not merely a presentation of banking rules on a general-purpose computer. It defines a machine-implemented routing and enforcement substrate in which namespace resolution, contract instantiation, transaction gating, cross-ledger settlement, evidence logging, and recovery actions are performed by interoperating software components coupled to ledger-resident contract interfaces and external payment or ledger networks.

### BACKGROUND

Conventional banking systems are centralized, account-centric, region-specific, and dependent on institution-specific identifiers. These identifiers do not inherently provide a deterministic route to a ledger-resident sub-bank contract, compliance block, risk threshold, collateral record, or settlement evidence repository.

Distributed ledgers provide durable recordkeeping, but heterogeneous ledgers frequently employ different address formats, consensus mechanisms, contract models, settlement finality rules, and compliance controls. A transaction associated with the same real-world user or institution can therefore be represented by inconsistent identifiers, causing ambiguous routing, duplicated contract instances, inconsistent state, difficult reconciliation, and weak auditability.

Existing digital currency and payment systems also often separate compliance logic, risk scoring, collateral management, brand authorization, and settlement evidence from the ledger-level execution path. This separation can make enforcement after-the-fact rather than protocol-level, can require redeployment of smart contracts when rules change, and can make it difficult to demonstrate which rule, risk score, jurisdictional parameter, or settlement state caused an acceptance, denial, throttle, freeze, escrow, liquidation, or routing decision.

A technical need therefore exists for a distributed computing system that resolves a domain identifier into a deterministic sub-bank contract and corresponding ledger route; applies pluggable jurisdiction-specific compliance blocks; computes risk indicators from ledger and identity or behavioral evidence; routes transactions across heterogeneous ledgers or external payment networks; records settlement evidence; and maintains an auditable record of compliance, risk, collateral, and governance actions.

### SUMMARY

Disclosed is a domain-routed sub-bank computing system that integrates a domain-based namespace, distributed-ledger sub-bank contracts, cross-ledger routing, AI-driven risk control, pluggable compliance enforcement, multi-form currency management, collateral and liquidation control, brand/franchise governance, and participation-state metadata control in a specific ordered computer-implemented architecture.

In one embodiment, a namespace management module stores a mapping between a domain identifier and a corresponding sub-bank smart contract deployed on one or more distributed ledgers or bound to a ledger-resident contract interface. The mapping may include a domain identifier, contract address, chain identifier, ledger route, jurisdiction tag, compliance package identifier, brand profile identifier, currency support parameter, collateral status, recovery parameter, revocation status, public-key pointer, wallet or account pointer, and audit-history pointer.

In one embodiment, a contract instantiation module deploys a new sub-bank smart contract, binds to an existing sub-bank smart contract, or registers a contract interface that controls ledger-resident sub-bank functions. The system checks for duplicate, conflicting, suspended, transferred, reserved, disputed, expired, or revoked namespace records before activation.

In one embodiment, a pluggable compliance enforcement module selects a compliance block based on jurisdictional, regional, industry, currency, risk, user, transaction, or brand parameters. An update interface may receive a revised compliance block, validate the revised block in a sandbox, assign a version identifier, and apply the updated block to future transactions without redeploying each sub-bank contract.

In one embodiment, an AI-driven risk control module generates a risk indicator from ledger transaction history, account behavior, device/session evidence, identity evidence, behavioral evidence, credit information, collateral condition, brand/franchise metrics, dispute data, chargeback data, or historical compliance outcomes. A gating controller uses the risk indicator and selected compliance block to approve, deny, throttle, freeze, limit, escrow, reverse where permitted, require collateral, require step-up verification, or route a transaction for review.

In one embodiment, a cross-ledger gateway routes permitted requests between a sub-bank contract and at least one external ledger, payment network, exchange system, custody system, clearing system, card rail, bank rail, stable-token network, or other value-transfer network. The gateway stores settlement evidence that links namespace, compliance, risk, route, and settlement state.

### BRIEF DESCRIPTION OF THE DRAWINGS

FIG. 1 is a system architecture diagram of an overall domain-routed transaction computing system including transaction request input 110, domain namespace registry 120, route object store 130, namespace resolver 140, ledger-resident contract interface 145, compliance block selector 150, AI risk directive engine 160, protocol-level gate 170, gateway or ledger adapters 180, and settlement evidence recorder 190.

FIG. 2 is a data-structure and hierarchy diagram of a domain namespace registry and route object including root domain namespace 210, country or region layer 220, industry layer 230, institution layer 240, canonical domain identifier 250, route object 260, domain hash 261, registry version 262, ledger network ID 263, contract interface ID 264, compliance profile ID 265, gateway policy ID 266, evidence schema ID 267, and route status 268.

FIG. 3 is a transaction request processing flow including receiving a transaction request 310, canonicalizing a domain identifier 320, resolving a route object 330, verifying active route status 340, selecting a compliance block 350, generating a risk directive 360, applying a protocol-level gate 370, rejecting, holding, or reviewing a request 375, executing a gateway or contract 380, and recording settlement evidence 390.

FIG. 4 is a versioned pluggable compliance block selection diagram including route object compliance metadata 410, jurisdiction, asset, or transaction type 420, compliance selector 430, KYC/AML block v1 441, sanctions or tax block v2 442, stable-token rule block 443, and pinned compliance result 450.

FIG. 5 is an AI risk indicator and enforcement directive generation diagram including namespace history 510, compliance result 520, identity or behavior evidence 530, device or session signal 540, settlement outcome history 550, feature vector builder 560, AI risk model 570, machine-readable enforcement directive 580, and directive schema store 590.

FIG. 6 is a protocol-level transaction gate state-machine diagram including pending request 610, compliance check 620, risk directive check 630, permitted execution 640, blocked, held, or review state 650, and evidence written state 660.

FIG. 7 is a cross-ledger gateway and external network adapter diagram including source ledger-resident contract interface 710, cross-ledger gateway controller 720, public ledger adapter 731, consortium ledger adapter 732, external payment network adapter 733, bank API or message adapter 734, and gateway proof or reconciliation result 740.

FIG. 8 is a settlement evidence record format diagram including settlement evidence record 800, namespace header 810, route header 820, compliance header 830, risk header 840, gateway header 850, settlement header 860, recovery header 870, signature or digest chain 880, protocol gate output 890, and append-only evidence log 895.

FIG. 9 is a bounded recovery process diagram including failure, breach, or timeout 910, evidence record verification 920, recovery-bounds check 930, recovery-action selection 940, and recovery evidence writing 950.

FIG. 10 is a multi-currency and collateral control module diagram including protocol-level gate 1010, multi-currency management 1020, collateral or state control module 1030, physical instruments 1041, payment cards 1042, stable tokens 1043, crypto assets 1044, time or behavior tokens 1045, and collateral registry 1046.

FIG. 11 is a physical instrument and queued validation diagram including paper, card, or biometric instrument 1110, instrument code or batch identifier 1120, ledger validation interface 1130, offline or queued event store 1140, replay or validation engine 1150, and evidence or risk update 1160.

FIG. 12 is a hierarchical domain namespace and policy-inheritance diagram including root namespace 1210, region policy layer 1220, industry policy layer 1230, institution or franchise layer 1240, user or domain-bound contract layer 1250, inherited policy constraints 1260, and override or quarantine rules 1270.

FIG. 13 is an external payment-network adapter and message translation diagram including permitted gated request 1310, external network adapter 1320, payment message format A 1331, payment message format B 1332, bank API instruction 1333, ledger transfer message 1334, and adapter receipt or network reference 1340.

FIG. 14 is an audit interface and asset-package diligence export diagram including settlement evidence records 1410, audit query processor 1420, diligence export package 1430, and export fields 1440.

FIG. 15 is a figure-to-claim support map identifying which figures support the system modules, namespace registry and route object, method steps, compliance block selection, AI risk directive generation, protocol-level gate, cross-ledger gateway, evidence record, bounded recovery, optional modules, and audit export.

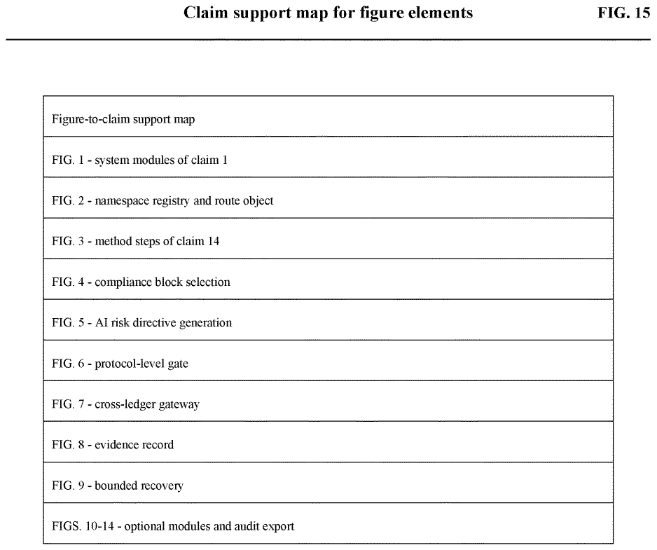

### DETAILED DESCRIPTION

The following description enables a person skilled in distributed systems, payment-network integration, ledger computing, identity management, and compliance automation to make and use the disclosed subject matter. Examples are provided for clarity and do not limit the claims unless expressly recited in a claim.

The terms domain identifier, domain namespace, namespace root, domain route, or domain-based key refer to a machine-resolvable identifier capable of being associated with a contract interface, ledger route, account or wallet pointer, compliance parameter, or audit history. The identifier may be a root domain, top-level domain, second-level domain, subdomain, institution-specific domain, user-specific domain, franchise domain, industry domain, or another hierarchical namespace key.

The term sub-bank smart contract refers to a ledger-resident contract, contract interface, contract bundle, account-control program, programmable ledger object, or equivalent executable or addressable component that implements sub-bank functions including balances, permissions, currency support, fee rules, compliance hooks, risk hooks, settlement hooks, collateral hooks, governance hooks, or evidence-recording hooks.

The phrase protocol-level gating refers to a computer-implemented decision point that controls whether a transaction request may propagate to a ledger, gateway, contract, payment rail, settlement channel, or audit state. Gating may occur before ledger invocation, during contract execution, before cross-ledger routing, or before release from escrow.

### Figure Reference Numerals, Data Structures, and Claim Support Map

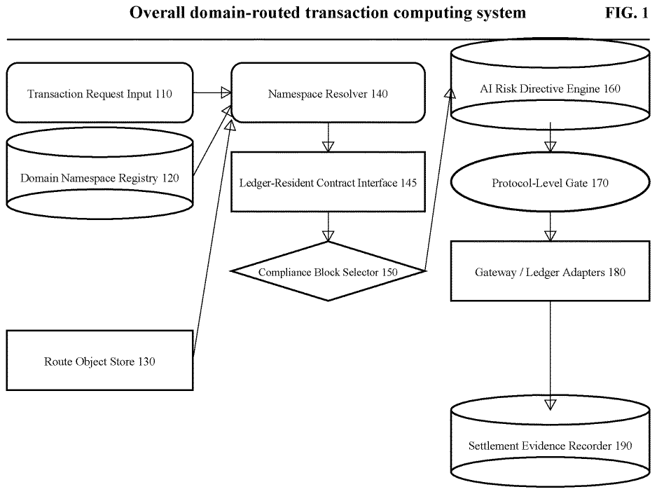

For FIG. 1, transaction request input 110 receives transaction data associated with a domain identifier; domain namespace registry 120 stores mappings; route object store 130 stores route objects; namespace resolver 140 resolves the domain identifier; ledger-resident contract interface 145 identifies the execution endpoint; compliance block selector 150 selects a versioned compliance block; AI risk directive engine 160 produces a risk indicator and enforcement directive; protocol-level gate 170 controls propagation; gateway or ledger adapters 180 perform permitted routing; and settlement evidence recorder 190 writes the evidence record.

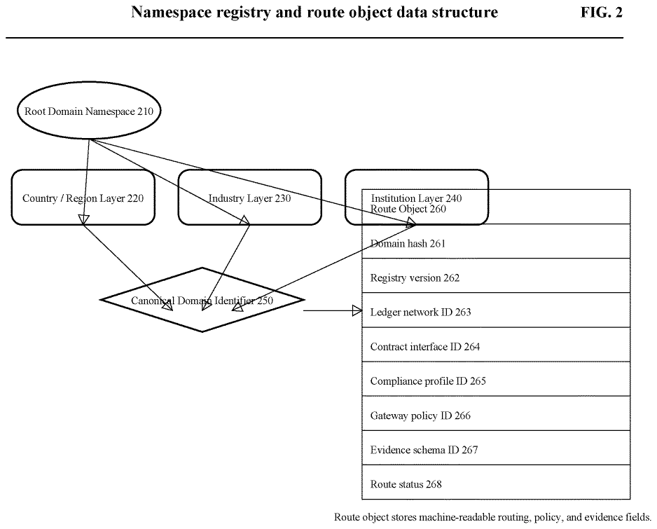

For FIG. 2, route object 260 is a machine-readable data structure associated with canonical domain identifier 250 and includes at least domain hash 261, registry version 262, ledger network ID 263, contract interface ID 264, compliance profile ID 265, gateway policy ID 266, evidence schema ID 267, and route status 268. These fields support the route-object limitations of the independent claims.

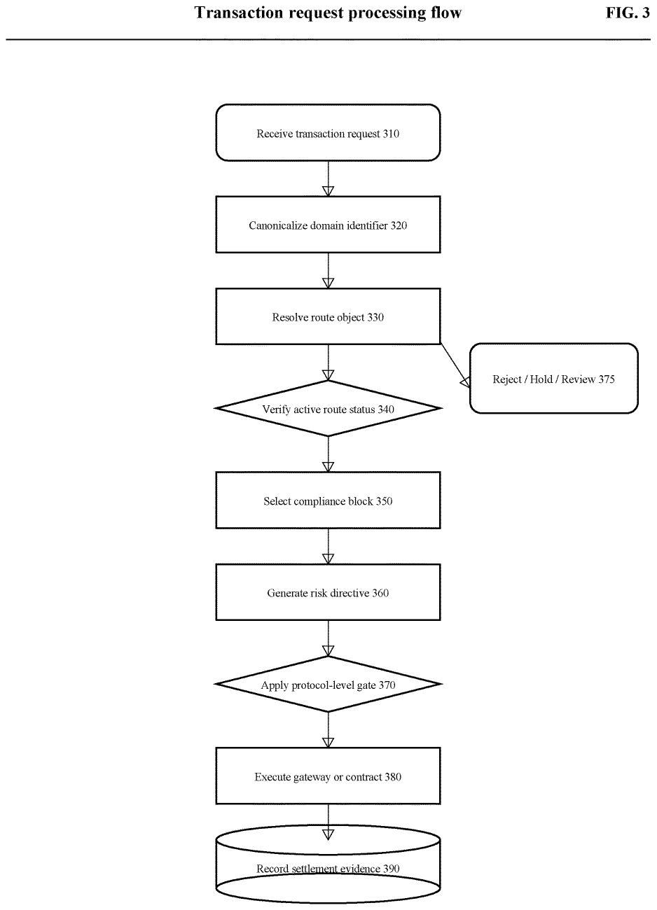

For FIG. 3, steps 310 through 390 correspond to the claimed computer-implemented method: receipt, canonicalization, route-object resolution, route-status verification, compliance-block selection, risk-directive generation, protocol-level gating, permitted execution, and settlement-evidence recording.

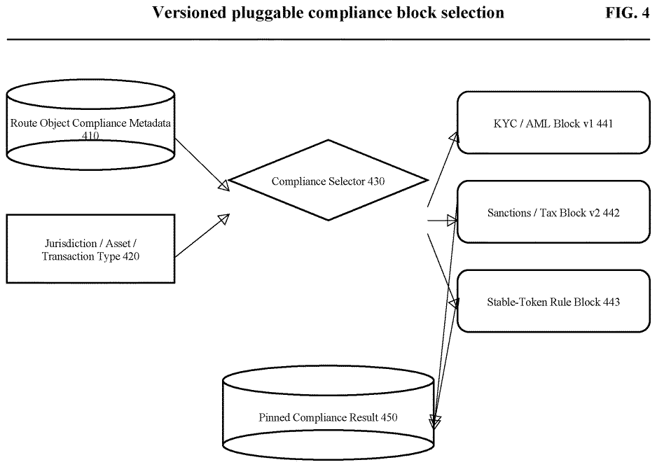

For FIG. 4, route object compliance metadata 410 and transaction context 420 are inputs to compliance selector 430, which chooses one of versioned compliance blocks 441-443 and outputs pinned compliance result 450. This supports claims directed to pluggable compliance selection, versioning, and update without redeploying the domain-to-contract mapping.

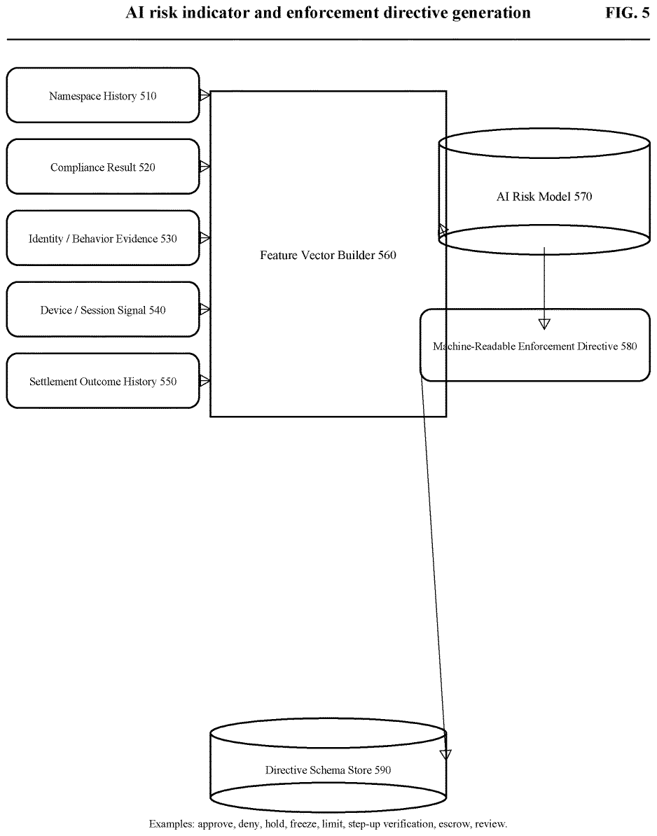

For FIG. 5, feature vector builder 560 receives namespace history 510, compliance result 520, identity or behavior evidence 530, device or session signal 540, and settlement outcome history 550. AI risk model 570 generates a risk output that is converted into machine-readable enforcement directive 580 using directive schema store 590.

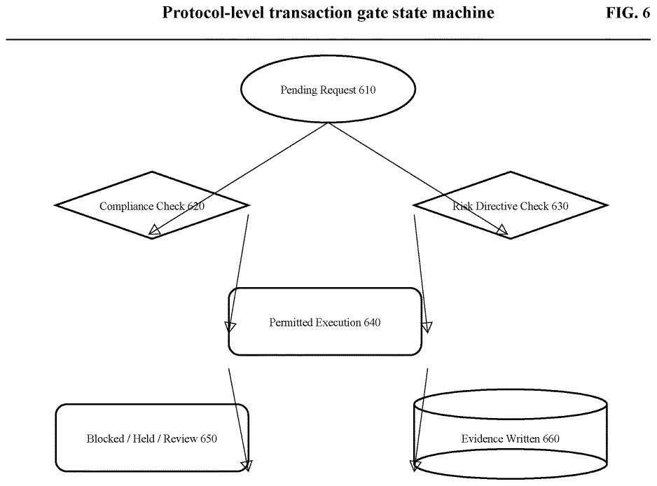

For FIG. 6, pending request 610 is checked against compliance check 620 and risk directive check 630. The protocol-level gate permits execution 640 or routes the request to blocked, held, or review state 650, with evidence written at 660. This supports pre-commit gating before signing, ledger submission, gateway bridging, or external payment-network transmission.

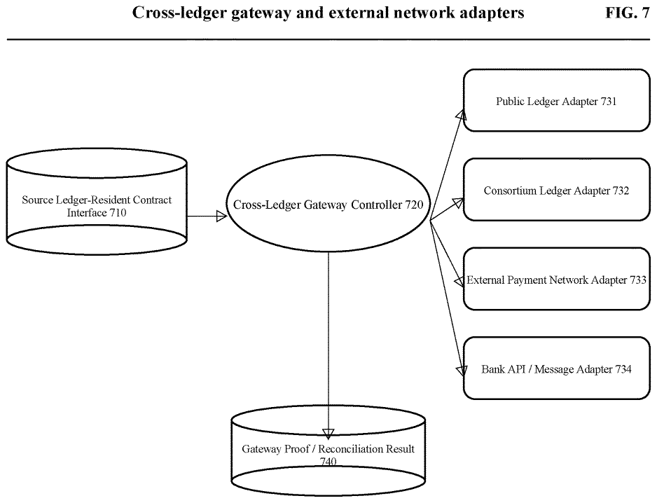

For FIG. 7, cross-ledger gateway controller 720 receives a permitted request from source ledger-resident contract interface 710 and selects adapters 731-734. Gateway proof or reconciliation result 740 is returned to the evidence recorder for settlement-state recording.

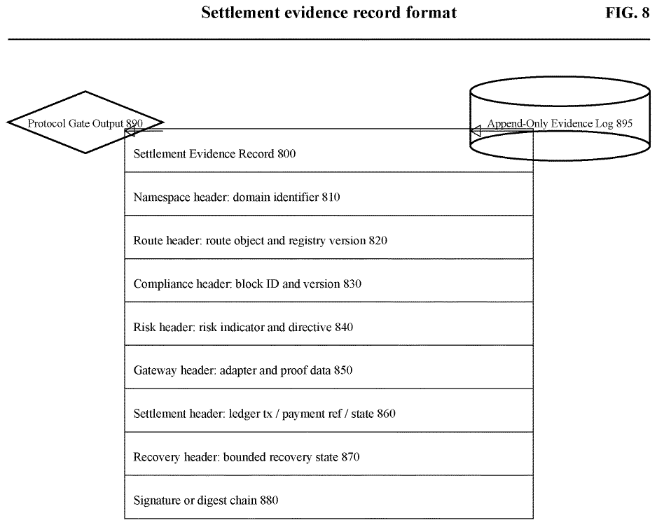

For FIG. 8, settlement evidence record 800 includes namespace header 810, route header 820, compliance header 830, risk header 840, gateway header 850, settlement header 860, recovery header 870, and signature or digest chain 880. The record may be written to append-only evidence log 895 after protocol gate output 890.

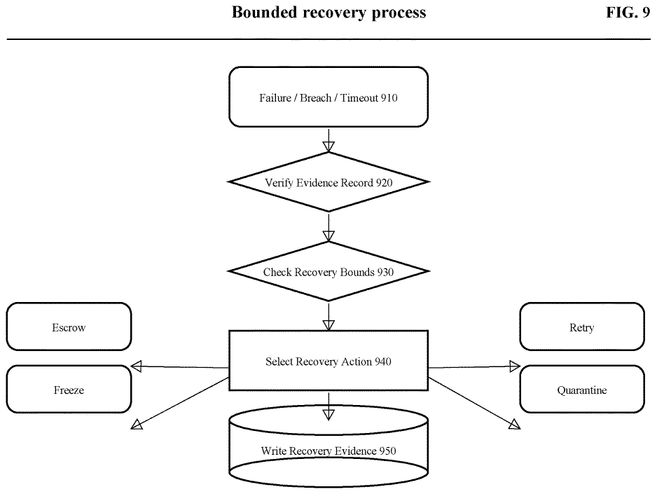

For FIG. 9, failure, breach, or timeout 910 triggers evidence verification 920, recovery-bounds check 930, recovery-action selection 940, and writing of recovery evidence 950. This supports bounded recovery limitations and failure handling.

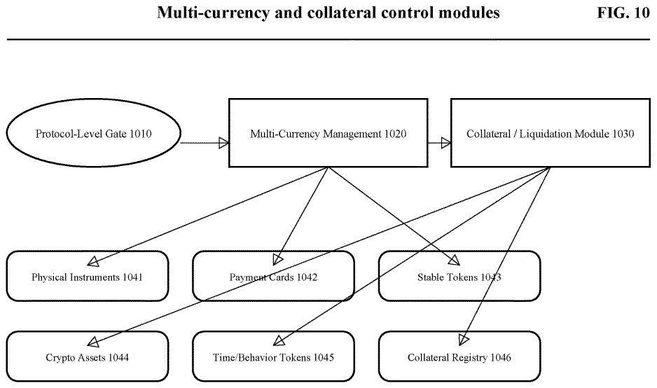

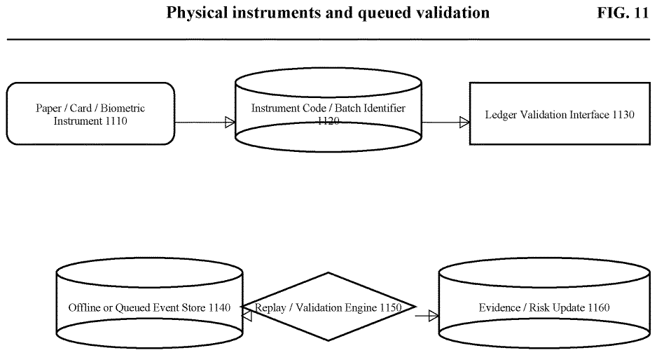

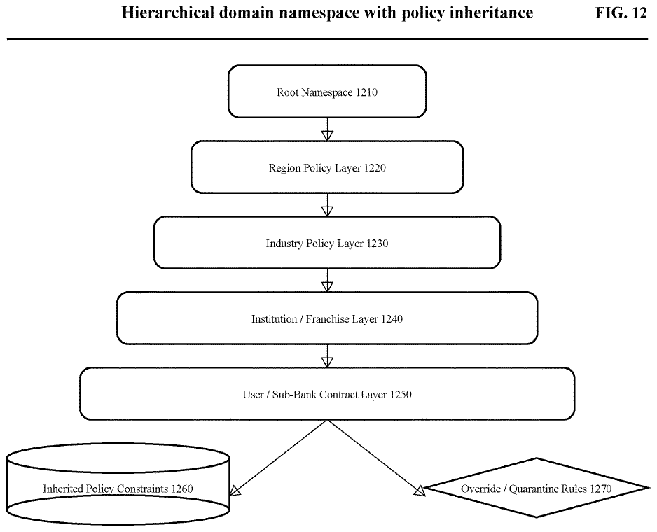

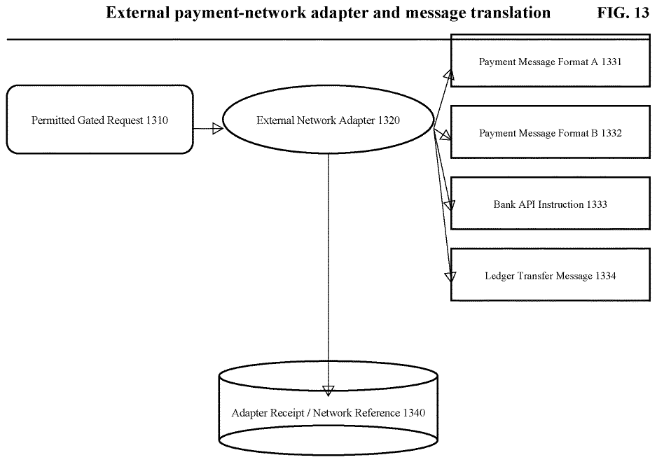

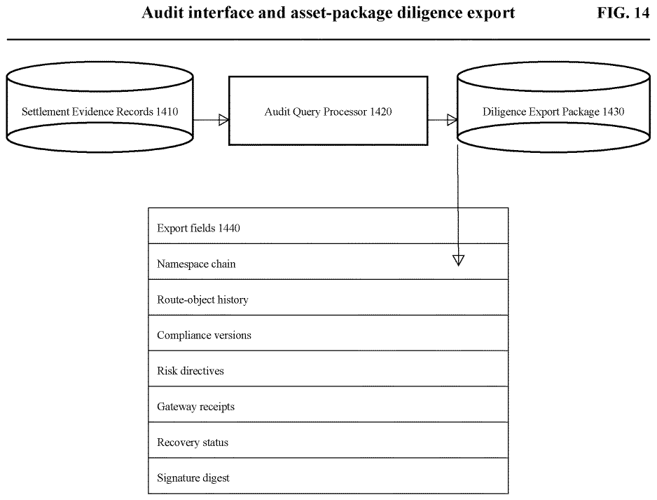

For FIGS. 10-14, optional value-instrument, collateral-state, physical or queued validation, namespace hierarchy, external payment adapter, and audit-export modules are shown as route-controlled technical states that operate through the same protocol-level gate and evidence-record architecture rather than as independent business results.

### 1. Domain Namespace Registry and Mapping Records

In one embodiment, the domain namespace registry is implemented by one or more processors executing instructions stored in non-transitory memory. The domain namespace registry communicates with other system components through signed application programming interfaces, message queues, smart-contract calls, gateway calls, or policy-enforced middleware. The module may be hosted by a central operator, a consortium service, a cloud cluster, an on-premises server, edge nodes, or a hybrid arrangement of sub-bank nodes.

The domain namespace registry receives input data including domain identifiers, user or institution identifiers, ledger routes, compliance parameters, risk parameters, collateral parameters, currency support parameters, brand parameters, public-key references, wallet or account references, and audit pointers. The module produces mapping records that are stored in a ledger, database, append-only log, Merkle tree, cryptographic commitment, or equivalent record store.

The technical problem addressed by this module includes namespace ambiguity and duplicate contract instances. The module addresses that problem by enforcing deterministic namespace association, versioned state recording, cryptographic authentication of administrative changes, and evidence-preserving linkage between the received request, selected route, applied rule, resulting state, and recorded audit artifact.

The module may operate in a centralized mode, decentralized mode, or hybrid mode. In a centralized mode, a trusted operator can approve records and compliance updates. In a decentralized mode, validators, consortium members, or authorized nodes may approve activation through consensus or multisignature control. In a hybrid mode, a central rule source may supply compliance packages while ledger nodes execute local transaction functions and preserve evidence locally.

To maintain auditability, the domain namespace registry may generate a record including a request identifier, domain identifier, timestamp, prior-state hash, post-state hash, compliance-block identifier, risk-indicator identifier, settlement identifier, user or operator credential, signature, version identifier, and retention pointer. A later audit can reconstruct the route and the reason for each state transition without relying solely on unstructured logs.

Implementation of the domain namespace registry may include separate subcomponents for intake, validation, transformation, route selection, state update, cryptographic signing, exception handling, and evidence emission. The subcomponents may execute synchronously in a transaction pipeline or asynchronously by generating a signed work item that is consumed by a subsequent contract, gateway, risk engine, compliance engine, or repository.

In some embodiments, a failure of the domain namespace registry does not necessarily invalidate all pending transactions. The system may place affected transactions into escrow, mark them for review, revert a pending instruction where permitted, generate a compensating transaction, or freeze a domain route pending verification. The cause of the recovery action is linked to the same namespace record and audit-history pointer used for the ordinary transaction path.

The domain namespace registry may be configured to expose an examiner-readable audit record showing the input, transformation, enforcement rule, and output. Such evidence-oriented configuration makes the module more than a generic business rule executed on a computer because it changes how routing, compliance selection, risk enforcement, and settlement proof are represented and preserved in the distributed computing architecture.

Example operation: when a transaction request invokes the domain namespace registry and mapping records component, the system verifies that the domain route is active, selects or verifies the relevant parameter set, creates or updates mapping records, and emits a signed evidence object that can be referenced by a later compliance review, dispute review, settlement reconciliation, or claim-support analysis.

### 2. Contract Instantiation and Binding

In one embodiment, the contract instantiation module is implemented by one or more processors executing instructions stored in non-transitory memory. The contract instantiation module communicates with other system components through signed application programming interfaces, message queues, smart-contract calls, gateway calls, or policy-enforced middleware. The module may be hosted by a central operator, a consortium service, a cloud cluster, an on-premises server, edge nodes, or a hybrid arrangement of sub-bank nodes.

The contract instantiation module receives input data including domain identifiers, user or institution identifiers, ledger routes, compliance parameters, risk parameters, collateral parameters, currency support parameters, brand parameters, public-key references, wallet or account references, and audit pointers. The module produces deployment and binding records that are stored in a ledger, database, append-only log, Merkle tree, cryptographic commitment, or equivalent record store.

The technical problem addressed by this module includes inconsistent contract creation and unresolved domain ownership. The module addresses that problem by enforcing deterministic namespace association, versioned state recording, cryptographic authentication of administrative changes, and evidence-preserving linkage between the received request, selected route, applied rule, resulting state, and recorded audit artifact.

The module may operate in a centralized mode, decentralized mode, or hybrid mode. In a centralized mode, a trusted operator can approve records and compliance updates. In a decentralized mode, validators, consortium members, or authorized nodes may approve activation through consensus or multisignature control. In a hybrid mode, a central rule source may supply compliance packages while ledger nodes execute local transaction functions and preserve evidence locally.

To maintain auditability, the contract instantiation module may generate a record including a request identifier, domain identifier, timestamp, prior-state hash, post-state hash, compliance-block identifier, risk-indicator identifier, settlement identifier, user or operator credential, signature, version identifier, and retention pointer. A later audit can reconstruct the route and the reason for each state transition without relying solely on unstructured logs.

Implementation of the contract instantiation module may include separate subcomponents for intake, validation, transformation, route selection, state update, cryptographic signing, exception handling, and evidence emission. The subcomponents may execute synchronously in a transaction pipeline or asynchronously by generating a signed work item that is consumed by a subsequent contract, gateway, risk engine, compliance engine, or repository.

In some embodiments, a failure of the contract instantiation module does not necessarily invalidate all pending transactions. The system may place affected transactions into escrow, mark them for review, revert a pending instruction where permitted, generate a compensating transaction, or freeze a domain route pending verification. The cause of the recovery action is linked to the same namespace record and audit-history pointer used for the ordinary transaction path.

The contract instantiation module may be configured to expose an examiner-readable audit record showing the input, transformation, enforcement rule, and output. Such evidence-oriented configuration makes the module more than a generic business rule executed on a computer because it changes how routing, compliance selection, risk enforcement, and settlement proof are represented and preserved in the distributed computing architecture.

Example operation: when a transaction request invokes the contract instantiation and binding component, the system verifies that the domain route is active, selects or verifies the relevant parameter set, creates or updates deployment and binding records, and emits a signed evidence object that can be referenced by a later compliance review, dispute review, settlement reconciliation, or claim-support analysis.

### 3. Transaction Intake and Namespace Resolution

In one embodiment, the transaction routing layer is implemented by one or more processors executing instructions stored in non-transitory memory. The transaction routing layer communicates with other system components through signed application programming interfaces, message queues, smart-contract calls, gateway calls, or policy-enforced middleware. The module may be hosted by a central operator, a consortium service, a cloud cluster, an on-premises server, edge nodes, or a hybrid arrangement of sub-bank nodes.

The transaction routing layer receives input data including domain identifiers, user or institution identifiers, ledger routes, compliance parameters, risk parameters, collateral parameters, currency support parameters, brand parameters, public-key references, wallet or account references, and audit pointers. The module produces domain-resolved transaction objects that are stored in a ledger, database, append-only log, Merkle tree, cryptographic commitment, or equivalent record store.

The technical problem addressed by this module includes ambiguous ledger endpoint selection. The module addresses that problem by enforcing deterministic namespace association, versioned state recording, cryptographic authentication of administrative changes, and evidence-preserving linkage between the received request, selected route, applied rule, resulting state, and recorded audit artifact.

The module may operate in a centralized mode, decentralized mode, or hybrid mode. In a centralized mode, a trusted operator can approve records and compliance updates. In a decentralized mode, validators, consortium members, or authorized nodes may approve activation through consensus or multisignature control. In a hybrid mode, a central rule source may supply compliance packages while ledger nodes execute local transaction functions and preserve evidence locally.

To maintain auditability, the transaction routing layer may generate a record including a request identifier, domain identifier, timestamp, prior-state hash, post-state hash, compliance-block identifier, risk-indicator identifier, settlement identifier, user or operator credential, signature, version identifier, and retention pointer. A later audit can reconstruct the route and the reason for each state transition without relying solely on unstructured logs.

Implementation of the transaction routing layer may include separate subcomponents for intake, validation, transformation, route selection, state update, cryptographic signing, exception handling, and evidence emission. The subcomponents may execute synchronously in a transaction pipeline or asynchronously by generating a signed work item that is consumed by a subsequent contract, gateway, risk engine, compliance engine, or repository.

In some embodiments, a failure of the transaction routing layer does not necessarily invalidate all pending transactions. The system may place affected transactions into escrow, mark them for review, revert a pending instruction where permitted, generate a compensating transaction, or freeze a domain route pending verification. The cause of the recovery action is linked to the same namespace record and audit-history pointer used for the ordinary transaction path.

The transaction routing layer may be configured to expose an examiner-readable audit record showing the input, transformation, enforcement rule, and output. Such evidence-oriented configuration makes the module more than a generic business rule executed on a computer because it changes how routing, compliance selection, risk enforcement, and settlement proof are represented and preserved in the distributed computing architecture.

Example operation: when a transaction request invokes the transaction intake and namespace resolution component, the system verifies that the domain route is active, selects or verifies the relevant parameter set, creates or updates domain-resolved transaction objects, and emits a signed evidence object that can be referenced by a later compliance review, dispute review, settlement reconciliation, or claim-support analysis.

### 4. Pluggable Compliance Enforcement

In one embodiment, the pluggable compliance engine is implemented by one or more processors executing instructions stored in non-transitory memory. The pluggable compliance engine communicates with other system components through signed application programming interfaces, message queues, smart-contract calls, gateway calls, or policy-enforced middleware. The module may be hosted by a central operator, a consortium service, a cloud cluster, an on-premises server, edge nodes, or a hybrid arrangement of sub-bank nodes.

The pluggable compliance engine receives input data including domain identifiers, user or institution identifiers, ledger routes, compliance parameters, risk parameters, collateral parameters, currency support parameters, brand parameters, public-key references, wallet or account references, and audit pointers. The module produces compliance blocks and version identifiers that are stored in a ledger, database, append-only log, Merkle tree, cryptographic commitment, or equivalent record store.

The technical problem addressed by this module includes off-ledger compliance gaps and redeployment burdens. The module addresses that problem by enforcing deterministic namespace association, versioned state recording, cryptographic authentication of administrative changes, and evidence-preserving linkage between the received request, selected route, applied rule, resulting state, and recorded audit artifact.

The module may operate in a centralized mode, decentralized mode, or hybrid mode. In a centralized mode, a trusted operator can approve records and compliance updates. In a decentralized mode, validators, consortium members, or authorized nodes may approve activation through consensus or multisignature control. In a hybrid mode, a central rule source may supply compliance packages while ledger nodes execute local transaction functions and preserve evidence locally.

To maintain auditability, the pluggable compliance engine may generate a record including a request identifier, domain identifier, timestamp, prior-state hash, post-state hash, compliance-block identifier, risk-indicator identifier, settlement identifier, user or operator credential, signature, version identifier, and retention pointer. A later audit can reconstruct the route and the reason for each state transition without relying solely on unstructured logs.

Implementation of the pluggable compliance engine may include separate subcomponents for intake, validation, transformation, route selection, state update, cryptographic signing, exception handling, and evidence emission. The subcomponents may execute synchronously in a transaction pipeline or asynchronously by generating a signed work item that is consumed by a subsequent contract, gateway, risk engine, compliance engine, or repository.

In some embodiments, a failure of the pluggable compliance engine does not necessarily invalidate all pending transactions. The system may place affected transactions into escrow, mark them for review, revert a pending instruction where permitted, generate a compensating transaction, or freeze a domain route pending verification. The cause of the recovery action is linked to the same namespace record and audit-history pointer used for the ordinary transaction path.

The pluggable compliance engine may be configured to expose an examiner-readable audit record showing the input, transformation, enforcement rule, and output. Such evidence-oriented configuration makes the module more than a generic business rule executed on a computer because it changes how routing, compliance selection, risk enforcement, and settlement proof are represented and preserved in the distributed computing architecture.

Example operation: when a transaction request invokes the pluggable compliance enforcement component, the system verifies that the domain route is active, selects or verifies the relevant parameter set, creates or updates compliance blocks and version identifiers, and emits a signed evidence object that can be referenced by a later compliance review, dispute review, settlement reconciliation, or claim-support analysis.

### 5. Compliance Update Interface

In one embodiment, the update interface and validation sandbox is implemented by one or more processors executing instructions stored in non-transitory memory. The update interface and validation sandbox communicates with other system components through signed application programming interfaces, message queues, smart-contract calls, gateway calls, or policy-enforced middleware. The module may be hosted by a central operator, a consortium service, a cloud cluster, an on-premises server, edge nodes, or a hybrid arrangement of sub-bank nodes.

The update interface and validation sandbox receives input data including domain identifiers, user or institution identifiers, ledger routes, compliance parameters, risk parameters, collateral parameters, currency support parameters, brand parameters, public-key references, wallet or account references, and audit pointers. The module produces updated compliance-block versions that are stored in a ledger, database, append-only log, Merkle tree, cryptographic commitment, or equivalent record store.

The technical problem addressed by this module includes rule-change disruption across many sub-bank nodes. The module addresses that problem by enforcing deterministic namespace association, versioned state recording, cryptographic authentication of administrative changes, and evidence-preserving linkage between the received request, selected route, applied rule, resulting state, and recorded audit artifact.

The module may operate in a centralized mode, decentralized mode, or hybrid mode. In a centralized mode, a trusted operator can approve records and compliance updates. In a decentralized mode, validators, consortium members, or authorized nodes may approve activation through consensus or multisignature control. In a hybrid mode, a central rule source may supply compliance packages while ledger nodes execute local transaction functions and preserve evidence locally.

To maintain auditability, the update interface and validation sandbox may generate a record including a request identifier, domain identifier, timestamp, prior-state hash, post-state hash, compliance-block identifier, risk-indicator identifier, settlement identifier, user or operator credential, signature, version identifier, and retention pointer. A later audit can reconstruct the route and the reason for each state transition without relying solely on unstructured logs.

Implementation of the update interface and validation sandbox may include separate subcomponents for intake, validation, transformation, route selection, state update, cryptographic signing, exception handling, and evidence emission. The subcomponents may execute synchronously in a transaction pipeline or asynchronously by generating a signed work item that is consumed by a subsequent contract, gateway, risk engine, compliance engine, or repository.

In some embodiments, a failure of the update interface and validation sandbox does not necessarily invalidate all pending transactions. The system may place affected transactions into escrow, mark them for review, revert a pending instruction where permitted, generate a compensating transaction, or freeze a domain route pending verification. The cause of the recovery action is linked to the same namespace record and audit-history pointer used for the ordinary transaction path.

The update interface and validation sandbox may be configured to expose an examiner-readable audit record showing the input, transformation, enforcement rule, and output. Such evidence-oriented configuration makes the module more than a generic business rule executed on a computer because it changes how routing, compliance selection, risk enforcement, and settlement proof are represented and preserved in the distributed computing architecture.

Example operation: when a transaction request invokes the compliance update interface component, the system verifies that the domain route is active, selects or verifies the relevant parameter set, creates or updates updated compliance-block versions, and emits a signed evidence object that can be referenced by a later compliance review, dispute review, settlement reconciliation, or claim-support analysis.

### 6. AI-Driven Risk Control

In one embodiment, the risk control engine is implemented by one or more processors executing instructions stored in non-transitory memory. The risk control engine communicates with other system components through signed application programming interfaces, message queues, smart-contract calls, gateway calls, or policy-enforced middleware. The module may be hosted by a central operator, a consortium service, a cloud cluster, an on-premises server, edge nodes, or a hybrid arrangement of sub-bank nodes.

The risk control engine receives input data including domain identifiers, user or institution identifiers, ledger routes, compliance parameters, risk parameters, collateral parameters, currency support parameters, brand parameters, public-key references, wallet or account references, and audit pointers. The module produces risk indicators and enforcement directives that are stored in a ledger, database, append-only log, Merkle tree, cryptographic commitment, or equivalent record store.

The technical problem addressed by this module includes after-the-fact fraud detection and unbounded propagation of suspect requests. The module addresses that problem by enforcing deterministic namespace association, versioned state recording, cryptographic authentication of administrative changes, and evidence-preserving linkage between the received request, selected route, applied rule, resulting state, and recorded audit artifact.

The module may operate in a centralized mode, decentralized mode, or hybrid mode. In a centralized mode, a trusted operator can approve records and compliance updates. In a decentralized mode, validators, consortium members, or authorized nodes may approve activation through consensus or multisignature control. In a hybrid mode, a central rule source may supply compliance packages while ledger nodes execute local transaction functions and preserve evidence locally.

To maintain auditability, the risk control engine may generate a record including a request identifier, domain identifier, timestamp, prior-state hash, post-state hash, compliance-block identifier, risk-indicator identifier, settlement identifier, user or operator credential, signature, version identifier, and retention pointer. A later audit can reconstruct the route and the reason for each state transition without relying solely on unstructured logs.

Implementation of the risk control engine may include separate subcomponents for intake, validation, transformation, route selection, state update, cryptographic signing, exception handling, and evidence emission. The subcomponents may execute synchronously in a transaction pipeline or asynchronously by generating a signed work item that is consumed by a subsequent contract, gateway, risk engine, compliance engine, or repository.

In some embodiments, a failure of the risk control engine does not necessarily invalidate all pending transactions. The system may place affected transactions into escrow, mark them for review, revert a pending instruction where permitted, generate a compensating transaction, or freeze a domain route pending verification. The cause of the recovery action is linked to the same namespace record and audit-history pointer used for the ordinary transaction path.

The risk control engine may be configured to expose an examiner-readable audit record showing the input, transformation, enforcement rule, and output. Such evidence-oriented configuration makes the module more than a generic business rule executed on a computer because it changes how routing, compliance selection, risk enforcement, and settlement proof are represented and preserved in the distributed computing architecture.

Example operation: when a transaction request invokes the ai-driven risk control component, the system verifies that the domain route is active, selects or verifies the relevant parameter set, creates or updates risk indicators and enforcement directives, and emits a signed evidence object that can be referenced by a later compliance review, dispute review, settlement reconciliation, or claim-support analysis.

### 7. Protocol-Level Gating

In one embodiment, the gating controller is implemented by one or more processors executing instructions stored in non-transitory memory. The gating controller communicates with other system components through signed application programming interfaces, message queues, smart-contract calls, gateway calls, or policy-enforced middleware. The module may be hosted by a central operator, a consortium service, a cloud cluster, an on-premises server, edge nodes, or a hybrid arrangement of sub-bank nodes.

The gating controller receives input data including domain identifiers, user or institution identifiers, ledger routes, compliance parameters, risk parameters, collateral parameters, currency support parameters, brand parameters, public-key references, wallet or account references, and audit pointers. The module produces accepted, denied, throttled, frozen, escrowed, or review-routed transaction states that are stored in a ledger, database, append-only log, Merkle tree, cryptographic commitment, or equivalent record store.

The technical problem addressed by this module includes uncontrolled propagation into external ledgers. The module addresses that problem by enforcing deterministic namespace association, versioned state recording, cryptographic authentication of administrative changes, and evidence-preserving linkage between the received request, selected route, applied rule, resulting state, and recorded audit artifact.

The module may operate in a centralized mode, decentralized mode, or hybrid mode. In a centralized mode, a trusted operator can approve records and compliance updates. In a decentralized mode, validators, consortium members, or authorized nodes may approve activation through consensus or multisignature control. In a hybrid mode, a central rule source may supply compliance packages while ledger nodes execute local transaction functions and preserve evidence locally.

To maintain auditability, the gating controller may generate a record including a request identifier, domain identifier, timestamp, prior-state hash, post-state hash, compliance-block identifier, risk-indicator identifier, settlement identifier, user or operator credential, signature, version identifier, and retention pointer. A later audit can reconstruct the route and the reason for each state transition without relying solely on unstructured logs.

Implementation of the gating controller may include separate subcomponents for intake, validation, transformation, route selection, state update, cryptographic signing, exception handling, and evidence emission. The subcomponents may execute synchronously in a transaction pipeline or asynchronously by generating a signed work item that is consumed by a subsequent contract, gateway, risk engine, compliance engine, or repository.

In some embodiments, a failure of the gating controller does not necessarily invalidate all pending transactions. The system may place affected transactions into escrow, mark them for review, revert a pending instruction where permitted, generate a compensating transaction, or freeze a domain route pending verification. The cause of the recovery action is linked to the same namespace record and audit-history pointer used for the ordinary transaction path.

The gating controller may be configured to expose an examiner-readable audit record showing the input, transformation, enforcement rule, and output. Such evidence-oriented configuration makes the module more than a generic business rule executed on a computer because it changes how routing, compliance selection, risk enforcement, and settlement proof are represented and preserved in the distributed computing architecture.

Example operation: when a transaction request invokes the protocol-level gating component, the system verifies that the domain route is active, selects or verifies the relevant parameter set, creates or updates accepted, denied, throttled, frozen, escrowed, or review-routed transaction states, and emits a signed evidence object that can be referenced by a later compliance review, dispute review, settlement reconciliation, or claim-support analysis.

### 8. Cross-Ledger Gateway

In one embodiment, the cross-ledger gateway is implemented by one or more processors executing instructions stored in non-transitory memory. The cross-ledger gateway communicates with other system components through signed application programming interfaces, message queues, smart-contract calls, gateway calls, or policy-enforced middleware. The module may be hosted by a central operator, a consortium service, a cloud cluster, an on-premises server, edge nodes, or a hybrid arrangement of sub-bank nodes.

The cross-ledger gateway receives input data including domain identifiers, user or institution identifiers, ledger routes, compliance parameters, risk parameters, collateral parameters, currency support parameters, brand parameters, public-key references, wallet or account references, and audit pointers. The module produces proofs, locks, escrow states, reconciliation records, and route identifiers that are stored in a ledger, database, append-only log, Merkle tree, cryptographic commitment, or equivalent record store.

The technical problem addressed by this module includes state inconsistency between heterogeneous ledgers. The module addresses that problem by enforcing deterministic namespace association, versioned state recording, cryptographic authentication of administrative changes, and evidence-preserving linkage between the received request, selected route, applied rule, resulting state, and recorded audit artifact.

The module may operate in a centralized mode, decentralized mode, or hybrid mode. In a centralized mode, a trusted operator can approve records and compliance updates. In a decentralized mode, validators, consortium members, or authorized nodes may approve activation through consensus or multisignature control. In a hybrid mode, a central rule source may supply compliance packages while ledger nodes execute local transaction functions and preserve evidence locally.

To maintain auditability, the cross-ledger gateway may generate a record including a request identifier, domain identifier, timestamp, prior-state hash, post-state hash, compliance-block identifier, risk-indicator identifier, settlement identifier, user or operator credential, signature, version identifier, and retention pointer. A later audit can reconstruct the route and the reason for each state transition without relying solely on unstructured logs.

Implementation of the cross-ledger gateway may include separate subcomponents for intake, validation, transformation, route selection, state update, cryptographic signing, exception handling, and evidence emission. The subcomponents may execute synchronously in a transaction pipeline or asynchronously by generating a signed work item that is consumed by a subsequent contract, gateway, risk engine, compliance engine, or repository.

In some embodiments, a failure of the cross-ledger gateway does not necessarily invalidate all pending transactions. The system may place affected transactions into escrow, mark them for review, revert a pending instruction where permitted, generate a compensating transaction, or freeze a domain route pending verification. The cause of the recovery action is linked to the same namespace record and audit-history pointer used for the ordinary transaction path.

The cross-ledger gateway may be configured to expose an examiner-readable audit record showing the input, transformation, enforcement rule, and output. Such evidence-oriented configuration makes the module more than a generic business rule executed on a computer because it changes how routing, compliance selection, risk enforcement, and settlement proof are represented and preserved in the distributed computing architecture.

Example operation: when a transaction request invokes the cross-ledger gateway component, the system verifies that the domain route is active, selects or verifies the relevant parameter set, creates or updates proofs, locks, escrow states, reconciliation records, and route identifiers, and emits a signed evidence object that can be referenced by a later compliance review, dispute review, settlement reconciliation, or claim-support analysis.

### 9. Settlement Evidence Repository

In one embodiment, the settlement evidence repository is implemented by one or more processors executing instructions stored in non-transitory memory. The settlement evidence repository communicates with other system components through signed application programming interfaces, message queues, smart-contract calls, gateway calls, or policy-enforced middleware. The module may be hosted by a central operator, a consortium service, a cloud cluster, an on-premises server, edge nodes, or a hybrid arrangement of sub-bank nodes.

The settlement evidence repository receives input data including domain identifiers, user or institution identifiers, ledger routes, compliance parameters, risk parameters, collateral parameters, currency support parameters, brand parameters, public-key references, wallet or account references, and audit pointers. The module produces namespace, compliance, risk, and settlement receipts that are stored in a ledger, database, append-only log, Merkle tree, cryptographic commitment, or equivalent record store.

The technical problem addressed by this module includes inability to prove why a route or rule caused a state transition. The module addresses that problem by enforcing deterministic namespace association, versioned state recording, cryptographic authentication of administrative changes, and evidence-preserving linkage between the received request, selected route, applied rule, resulting state, and recorded audit artifact.

The module may operate in a centralized mode, decentralized mode, or hybrid mode. In a centralized mode, a trusted operator can approve records and compliance updates. In a decentralized mode, validators, consortium members, or authorized nodes may approve activation through consensus or multisignature control. In a hybrid mode, a central rule source may supply compliance packages while ledger nodes execute local transaction functions and preserve evidence locally.

To maintain auditability, the settlement evidence repository may generate a record including a request identifier, domain identifier, timestamp, prior-state hash, post-state hash, compliance-block identifier, risk-indicator identifier, settlement identifier, user or operator credential, signature, version identifier, and retention pointer. A later audit can reconstruct the route and the reason for each state transition without relying solely on unstructured logs.

Implementation of the settlement evidence repository may include separate subcomponents for intake, validation, transformation, route selection, state update, cryptographic signing, exception handling, and evidence emission. The subcomponents may execute synchronously in a transaction pipeline or asynchronously by generating a signed work item that is consumed by a subsequent contract, gateway, risk engine, compliance engine, or repository.

In some embodiments, a failure of the settlement evidence repository does not necessarily invalidate all pending transactions. The system may place affected transactions into escrow, mark them for review, revert a pending instruction where permitted, generate a compensating transaction, or freeze a domain route pending verification. The cause of the recovery action is linked to the same namespace record and audit-history pointer used for the ordinary transaction path.

The settlement evidence repository may be configured to expose an examiner-readable audit record showing the input, transformation, enforcement rule, and output. Such evidence-oriented configuration makes the module more than a generic business rule executed on a computer because it changes how routing, compliance selection, risk enforcement, and settlement proof are represented and preserved in the distributed computing architecture.

Example operation: when a transaction request invokes the settlement evidence repository component, the system verifies that the domain route is active, selects or verifies the relevant parameter set, creates or updates namespace, compliance, risk, and settlement receipts, and emits a signed evidence object that can be referenced by a later compliance review, dispute review, settlement reconciliation, or claim-support analysis.

### 10. Multi-Currency Management

In one embodiment, the multi-currency module is implemented by one or more processors executing instructions stored in non-transitory memory. The multi-currency module communicates with other system components through signed application programming interfaces, message queues, smart-contract calls, gateway calls, or policy-enforced middleware. The module may be hosted by a central operator, a consortium service, a cloud cluster, an on-premises server, edge nodes, or a hybrid arrangement of sub-bank nodes.

The multi-currency module receives input data including domain identifiers, user or institution identifiers, ledger routes, compliance parameters, risk parameters, collateral parameters, currency support parameters, brand parameters, public-key references, wallet or account references, and audit pointers. The module produces issuance, redemption, transfer, and exchange parameters that are stored in a ledger, database, append-only log, Merkle tree, cryptographic commitment, or equivalent record store.

The technical problem addressed by this module includes disconnected physical and digital value representations. The module addresses that problem by enforcing deterministic namespace association, versioned state recording, cryptographic authentication of administrative changes, and evidence-preserving linkage between the received request, selected route, applied rule, resulting state, and recorded audit artifact.

The module may operate in a centralized mode, decentralized mode, or hybrid mode. In a centralized mode, a trusted operator can approve records and compliance updates. In a decentralized mode, validators, consortium members, or authorized nodes may approve activation through consensus or multisignature control. In a hybrid mode, a central rule source may supply compliance packages while ledger nodes execute local transaction functions and preserve evidence locally.

To maintain auditability, the multi-currency module may generate a record including a request identifier, domain identifier, timestamp, prior-state hash, post-state hash, compliance-block identifier, risk-indicator identifier, settlement identifier, user or operator credential, signature, version identifier, and retention pointer. A later audit can reconstruct the route and the reason for each state transition without relying solely on unstructured logs.

Implementation of the multi-currency module may include separate subcomponents for intake, validation, transformation, route selection, state update, cryptographic signing, exception handling, and evidence emission. The subcomponents may execute synchronously in a transaction pipeline or asynchronously by generating a signed work item that is consumed by a subsequent contract, gateway, risk engine, compliance engine, or repository.

In some embodiments, a failure of the multi-currency module does not necessarily invalidate all pending transactions. The system may place affected transactions into escrow, mark them for review, revert a pending instruction where permitted, generate a compensating transaction, or freeze a domain route pending verification. The cause of the recovery action is linked to the same namespace record and audit-history pointer used for the ordinary transaction path.

The multi-currency module may be configured to expose an examiner-readable audit record showing the input, transformation, enforcement rule, and output. Such evidence-oriented configuration makes the module more than a generic business rule executed on a computer because it changes how routing, compliance selection, risk enforcement, and settlement proof are represented and preserved in the distributed computing architecture.

Example operation: when a transaction request invokes the multi-currency management component, the system verifies that the domain route is active, selects or verifies the relevant parameter set, creates or updates issuance, redemption, transfer, and exchange parameters, and emits a signed evidence object that can be referenced by a later compliance review, dispute review, settlement reconciliation, or claim-support analysis.

### 11. Collateral and Liquidation Control

In one embodiment, the collateral and liquidation module is implemented by one or more processors executing instructions stored in non-transitory memory. The collateral and liquidation module communicates with other system components through signed application programming interfaces, message queues, smart-contract calls, gateway calls, or policy-enforced middleware. The module may be hosted by a central operator, a consortium service, a cloud cluster, an on-premises server, edge nodes, or a hybrid arrangement of sub-bank nodes.

The collateral and liquidation module receives input data including domain identifiers, user or institution identifiers, ledger routes, compliance parameters, risk parameters, collateral parameters, currency support parameters, brand parameters, public-key references, wallet or account references, and audit pointers. The module produces collateral monitoring and bounded liquidation instructions that are stored in a ledger, database, append-only log, Merkle tree, cryptographic commitment, or equivalent record store.

The technical problem addressed by this module includes manual collateral enforcement and untraceable liquidation events. The module addresses that problem by enforcing deterministic namespace association, versioned state recording, cryptographic authentication of administrative changes, and evidence-preserving linkage between the received request, selected route, applied rule, resulting state, and recorded audit artifact.

The module may operate in a centralized mode, decentralized mode, or hybrid mode. In a centralized mode, a trusted operator can approve records and compliance updates. In a decentralized mode, validators, consortium members, or authorized nodes may approve activation through consensus or multisignature control. In a hybrid mode, a central rule source may supply compliance packages while ledger nodes execute local transaction functions and preserve evidence locally.

To maintain auditability, the collateral and liquidation module may generate a record including a request identifier, domain identifier, timestamp, prior-state hash, post-state hash, compliance-block identifier, risk-indicator identifier, settlement identifier, user or operator credential, signature, version identifier, and retention pointer. A later audit can reconstruct the route and the reason for each state transition without relying solely on unstructured logs.

Implementation of the collateral and liquidation module may include separate subcomponents for intake, validation, transformation, route selection, state update, cryptographic signing, exception handling, and evidence emission. The subcomponents may execute synchronously in a transaction pipeline or asynchronously by generating a signed work item that is consumed by a subsequent contract, gateway, risk engine, compliance engine, or repository.

In some embodiments, a failure of the collateral and liquidation module does not necessarily invalidate all pending transactions. The system may place affected transactions into escrow, mark them for review, revert a pending instruction where permitted, generate a compensating transaction, or freeze a domain route pending verification. The cause of the recovery action is linked to the same namespace record and audit-history pointer used for the ordinary transaction path.

The collateral and liquidation module may be configured to expose an examiner-readable audit record showing the input, transformation, enforcement rule, and output. Such evidence-oriented configuration makes the module more than a generic business rule executed on a computer because it changes how routing, compliance selection, risk enforcement, and settlement proof are represented and preserved in the distributed computing architecture.

Example operation: when a transaction request invokes the collateral and liquidation control component, the system verifies that the domain route is active, selects or verifies the relevant parameter set, creates or updates collateral monitoring and bounded liquidation instructions, and emits a signed evidence object that can be referenced by a later compliance review, dispute review, settlement reconciliation, or claim-support analysis.

### 12. Brand-Franchise Governance

In one embodiment, the brand-franchise management module is implemented by one or more processors executing instructions stored in non-transitory memory. The brand-franchise management module communicates with other system components through signed application programming interfaces, message queues, smart-contract calls, gateway calls, or policy-enforced middleware. The module may be hosted by a central operator, a consortium service, a cloud cluster, an on-premises server, edge nodes, or a hybrid arrangement of sub-bank nodes.

The brand-franchise management module receives input data including domain identifiers, user or institution identifiers, ledger routes, compliance parameters, risk parameters, collateral parameters, currency support parameters, brand parameters, public-key references, wallet or account references, and audit pointers. The module produces brand standards, operator-policy amounts, operator credentials, and revocation records that are stored in a ledger, database, append-only log, Merkle tree, cryptographic commitment, or equivalent record store.

The technical problem addressed by this module includes uncontrolled local operator divergence. The module addresses that problem by enforcing deterministic namespace association, versioned state recording, cryptographic authentication of administrative changes, and evidence-preserving linkage between the received request, selected route, applied rule, resulting state, and recorded audit artifact.

The module may operate in a centralized mode, decentralized mode, or hybrid mode. In a centralized mode, a trusted operator can approve records and compliance updates. In a decentralized mode, validators, consortium members, or authorized nodes may approve activation through consensus or multisignature control. In a hybrid mode, a central rule source may supply compliance packages while ledger nodes execute local transaction functions and preserve evidence locally.

To maintain auditability, the brand-franchise management module may generate a record including a request identifier, domain identifier, timestamp, prior-state hash, post-state hash, compliance-block identifier, risk-indicator identifier, settlement identifier, user or operator credential, signature, version identifier, and retention pointer. A later audit can reconstruct the route and the reason for each state transition without relying solely on unstructured logs.

Implementation of the brand-franchise management module may include separate subcomponents for intake, validation, transformation, route selection, state update, cryptographic signing, exception handling, and evidence emission. The subcomponents may execute synchronously in a transaction pipeline or asynchronously by generating a signed work item that is consumed by a subsequent contract, gateway, risk engine, compliance engine, or repository.

In some embodiments, a failure of the brand-franchise management module does not necessarily invalidate all pending transactions. The system may place affected transactions into escrow, mark them for review, revert a pending instruction where permitted, generate a compensating transaction, or freeze a domain route pending verification. The cause of the recovery action is linked to the same namespace record and audit-history pointer used for the ordinary transaction path.

The brand-franchise management module may be configured to expose an examiner-readable audit record showing the input, transformation, enforcement rule, and output. Such evidence-oriented configuration makes the module more than a generic business rule executed on a computer because it changes how routing, compliance selection, risk enforcement, and settlement proof are represented and preserved in the distributed computing architecture.

Example operation: when a transaction request invokes the brand-franchise governance component, the system verifies that the domain route is active, selects or verifies the relevant parameter set, creates or updates brand standards, operator-policy amounts, operator credentials, and revocation records, and emits a signed evidence object that can be referenced by a later compliance review, dispute review, settlement reconciliation, or claim-support analysis.

### 13. Participation-State Metadata and Governance Records

In one embodiment, the participation-state metadata module is implemented by one or more processors executing instructions stored in non-transitory memory. The participation-state metadata module communicates with other system components through signed application programming interfaces, message queues, smart-contract calls, gateway calls, or policy-enforced middleware. The module may be hosted by a central operator, a consortium service, a cloud cluster, an on-premises server, edge nodes, or a hybrid arrangement of sub-bank nodes.

The participation-state metadata module receives input data including domain identifiers, user or institution identifiers, ledger routes, compliance parameters, risk parameters, collateral parameters, currency support parameters, brand parameters, public-key references, wallet or account references, and audit pointers. The module produces governance-state, participation-state, and service-level records that are stored in a ledger, database, append-only log, Merkle tree, cryptographic commitment, or equivalent record store.

The technical problem addressed by this module includes unverifiable participation-state and governance-state updates. The module addresses that problem by enforcing deterministic namespace association, versioned state recording, cryptographic authentication of administrative changes, and evidence-preserving linkage between the received request, selected route, applied rule, resulting state, and recorded audit artifact.

The module may operate in a centralized mode, decentralized mode, or hybrid mode. In a centralized mode, a trusted operator can approve records and compliance updates. In a decentralized mode, validators, consortium members, or authorized nodes may approve activation through consensus or multisignature control. In a hybrid mode, a central rule source may supply compliance packages while ledger nodes execute local transaction functions and preserve evidence locally.

To maintain auditability, the participation-state metadata module may generate a record including a request identifier, domain identifier, timestamp, prior-state hash, post-state hash, compliance-block identifier, risk-indicator identifier, settlement identifier, user or operator credential, signature, version identifier, and retention pointer. A later audit can reconstruct the route and the reason for each state transition without relying solely on unstructured logs.

Implementation of the participation-state metadata module may include separate subcomponents for intake, validation, transformation, route selection, state update, cryptographic signing, exception handling, and evidence emission. The subcomponents may execute synchronously in a transaction pipeline or asynchronously by generating a signed work item that is consumed by a subsequent contract, gateway, risk engine, compliance engine, or repository.

In some embodiments, a failure of the participation-state metadata module does not necessarily invalidate all pending transactions. The system may place affected transactions into escrow, mark them for review, revert a pending instruction where permitted, generate a compensating transaction, or freeze a domain route pending verification. The cause of the recovery action is linked to the same namespace record and audit-history pointer used for the ordinary transaction path.

The participation-state metadata module may be configured to expose an examiner-readable audit record showing the input, transformation, enforcement rule, and output. Such evidence-oriented configuration makes the module more than a generic business rule executed on a computer because it changes how routing, compliance selection, risk enforcement, and settlement proof are represented and preserved in the distributed computing architecture.

Example operation: when a transaction request invokes the co-ownership and participation tokens component, the system verifies that the domain route is active, selects or verifies the relevant parameter set, creates or updates governance-state, participation-state, and service-level records, and emits a signed evidence object that can be referenced by a later compliance review, dispute review, settlement reconciliation, or claim-support analysis.

### 14. Security, Signatures, and Attestation

In one embodiment, the security subsystem is implemented by one or more processors executing instructions stored in non-transitory memory. The security subsystem communicates with other system components through signed application programming interfaces, message queues, smart-contract calls, gateway calls, or policy-enforced middleware. The module may be hosted by a central operator, a consortium service, a cloud cluster, an on-premises server, edge nodes, or a hybrid arrangement of sub-bank nodes.

The security subsystem receives input data including domain identifiers, user or institution identifiers, ledger routes, compliance parameters, risk parameters, collateral parameters, currency support parameters, brand parameters, public-key references, wallet or account references, and audit pointers. The module produces keys, signatures, attestation records, revocation lists, and audit proofs that are stored in a ledger, database, append-only log, Merkle tree, cryptographic commitment, or equivalent record store.

The technical problem addressed by this module includes identity spoofing and unauthorized administrative actions. The module addresses that problem by enforcing deterministic namespace association, versioned state recording, cryptographic authentication of administrative changes, and evidence-preserving linkage between the received request, selected route, applied rule, resulting state, and recorded audit artifact.

The module may operate in a centralized mode, decentralized mode, or hybrid mode. In a centralized mode, a trusted operator can approve records and compliance updates. In a decentralized mode, validators, consortium members, or authorized nodes may approve activation through consensus or multisignature control. In a hybrid mode, a central rule source may supply compliance packages while ledger nodes execute local transaction functions and preserve evidence locally.

To maintain auditability, the security subsystem may generate a record including a request identifier, domain identifier, timestamp, prior-state hash, post-state hash, compliance-block identifier, risk-indicator identifier, settlement identifier, user or operator credential, signature, version identifier, and retention pointer. A later audit can reconstruct the route and the reason for each state transition without relying solely on unstructured logs.

Implementation of the security subsystem may include separate subcomponents for intake, validation, transformation, route selection, state update, cryptographic signing, exception handling, and evidence emission. The subcomponents may execute synchronously in a transaction pipeline or asynchronously by generating a signed work item that is consumed by a subsequent contract, gateway, risk engine, compliance engine, or repository.

In some embodiments, a failure of the security subsystem does not necessarily invalidate all pending transactions. The system may place affected transactions into escrow, mark them for review, revert a pending instruction where permitted, generate a compensating transaction, or freeze a domain route pending verification. The cause of the recovery action is linked to the same namespace record and audit-history pointer used for the ordinary transaction path.

The security subsystem may be configured to expose an examiner-readable audit record showing the input, transformation, enforcement rule, and output. Such evidence-oriented configuration makes the module more than a generic business rule executed on a computer because it changes how routing, compliance selection, risk enforcement, and settlement proof are represented and preserved in the distributed computing architecture.

Example operation: when a transaction request invokes the security, signatures, and attestation component, the system verifies that the domain route is active, selects or verifies the relevant parameter set, creates or updates keys, signatures, attestation records, revocation lists, and audit proofs, and emits a signed evidence object that can be referenced by a later compliance review, dispute review, settlement reconciliation, or claim-support analysis.

### 15. External Payment and Banking Rail Adapters

In one embodiment, the rail adapter layer is implemented by one or more processors executing instructions stored in non-transitory memory. The rail adapter layer communicates with other system components through signed application programming interfaces, message queues, smart-contract calls, gateway calls, or policy-enforced middleware. The module may be hosted by a central operator, a consortium service, a cloud cluster, an on-premises server, edge nodes, or a hybrid arrangement of sub-bank nodes.

The rail adapter layer receives input data including domain identifiers, user or institution identifiers, ledger routes, compliance parameters, risk parameters, collateral parameters, currency support parameters, brand parameters, public-key references, wallet or account references, and audit pointers. The module produces ACH, card, wire, real-time payment, stable-token, and exchange adapters that are stored in a ledger, database, append-only log, Merkle tree, cryptographic commitment, or equivalent record store.

The technical problem addressed by this module includes loss of domain-rooted control when entering legacy rails. The module addresses that problem by enforcing deterministic namespace association, versioned state recording, cryptographic authentication of administrative changes, and evidence-preserving linkage between the received request, selected route, applied rule, resulting state, and recorded audit artifact.

The module may operate in a centralized mode, decentralized mode, or hybrid mode. In a centralized mode, a trusted operator can approve records and compliance updates. In a decentralized mode, validators, consortium members, or authorized nodes may approve activation through consensus or multisignature control. In a hybrid mode, a central rule source may supply compliance packages while ledger nodes execute local transaction functions and preserve evidence locally.

To maintain auditability, the rail adapter layer may generate a record including a request identifier, domain identifier, timestamp, prior-state hash, post-state hash, compliance-block identifier, risk-indicator identifier, settlement identifier, user or operator credential, signature, version identifier, and retention pointer. A later audit can reconstruct the route and the reason for each state transition without relying solely on unstructured logs.

Implementation of the rail adapter layer may include separate subcomponents for intake, validation, transformation, route selection, state update, cryptographic signing, exception handling, and evidence emission. The subcomponents may execute synchronously in a transaction pipeline or asynchronously by generating a signed work item that is consumed by a subsequent contract, gateway, risk engine, compliance engine, or repository.

In some embodiments, a failure of the rail adapter layer does not necessarily invalidate all pending transactions. The system may place affected transactions into escrow, mark them for review, revert a pending instruction where permitted, generate a compensating transaction, or freeze a domain route pending verification. The cause of the recovery action is linked to the same namespace record and audit-history pointer used for the ordinary transaction path.

The rail adapter layer may be configured to expose an examiner-readable audit record showing the input, transformation, enforcement rule, and output. Such evidence-oriented configuration makes the module more than a generic business rule executed on a computer because it changes how routing, compliance selection, risk enforcement, and settlement proof are represented and preserved in the distributed computing architecture.

Example operation: when a transaction request invokes the external payment and banking rail adapters component, the system verifies that the domain route is active, selects or verifies the relevant parameter set, creates or updates ACH, card, wire, real-time payment, stable-token, and exchange adapters, and emits a signed evidence object that can be referenced by a later compliance review, dispute review, settlement reconciliation, or claim-support analysis.

### 16. Failure Recovery and Rollback Control

In one embodiment, the bounded recovery controller is implemented by one or more processors executing instructions stored in non-transitory memory. The bounded recovery controller communicates with other system components through signed application programming interfaces, message queues, smart-contract calls, gateway calls, or policy-enforced middleware. The module may be hosted by a central operator, a consortium service, a cloud cluster, an on-premises server, edge nodes, or a hybrid arrangement of sub-bank nodes.

The bounded recovery controller receives input data including domain identifiers, user or institution identifiers, ledger routes, compliance parameters, risk parameters, collateral parameters, currency support parameters, brand parameters, public-key references, wallet or account references, and audit pointers. The module produces escrow, freeze, compensating transaction, dispute marking, and administrative-review states that are stored in a ledger, database, append-only log, Merkle tree, cryptographic commitment, or equivalent record store.

The technical problem addressed by this module includes unbounded or undocumented recovery after failed settlement. The module addresses that problem by enforcing deterministic namespace association, versioned state recording, cryptographic authentication of administrative changes, and evidence-preserving linkage between the received request, selected route, applied rule, resulting state, and recorded audit artifact.

The module may operate in a centralized mode, decentralized mode, or hybrid mode. In a centralized mode, a trusted operator can approve records and compliance updates. In a decentralized mode, validators, consortium members, or authorized nodes may approve activation through consensus or multisignature control. In a hybrid mode, a central rule source may supply compliance packages while ledger nodes execute local transaction functions and preserve evidence locally.

To maintain auditability, the bounded recovery controller may generate a record including a request identifier, domain identifier, timestamp, prior-state hash, post-state hash, compliance-block identifier, risk-indicator identifier, settlement identifier, user or operator credential, signature, version identifier, and retention pointer. A later audit can reconstruct the route and the reason for each state transition without relying solely on unstructured logs.

Implementation of the bounded recovery controller may include separate subcomponents for intake, validation, transformation, route selection, state update, cryptographic signing, exception handling, and evidence emission. The subcomponents may execute synchronously in a transaction pipeline or asynchronously by generating a signed work item that is consumed by a subsequent contract, gateway, risk engine, compliance engine, or repository.

In some embodiments, a failure of the bounded recovery controller does not necessarily invalidate all pending transactions. The system may place affected transactions into escrow, mark them for review, revert a pending instruction where permitted, generate a compensating transaction, or freeze a domain route pending verification. The cause of the recovery action is linked to the same namespace record and audit-history pointer used for the ordinary transaction path.

The bounded recovery controller may be configured to expose an examiner-readable audit record showing the input, transformation, enforcement rule, and output. Such evidence-oriented configuration makes the module more than a generic business rule executed on a computer because it changes how routing, compliance selection, risk enforcement, and settlement proof are represented and preserved in the distributed computing architecture.

Example operation: when a transaction request invokes the failure recovery and rollback control component, the system verifies that the domain route is active, selects or verifies the relevant parameter set, creates or updates escrow, freeze, compensating transaction, dispute marking, and administrative-review states, and emits a signed evidence object that can be referenced by a later compliance review, dispute review, settlement reconciliation, or claim-support analysis.

### 17. Audit Dashboard and Examiner-Visible Evidence

In one embodiment, the audit and dashboard layer is implemented by one or more processors executing instructions stored in non-transitory memory. The audit and dashboard layer communicates with other system components through signed application programming interfaces, message queues, smart-contract calls, gateway calls, or policy-enforced middleware. The module may be hosted by a central operator, a consortium service, a cloud cluster, an on-premises server, edge nodes, or a hybrid arrangement of sub-bank nodes.

The audit and dashboard layer receives input data including domain identifiers, user or institution identifiers, ledger routes, compliance parameters, risk parameters, collateral parameters, currency support parameters, brand parameters, public-key references, wallet or account references, and audit pointers. The module produces claim-correlated logs and evidence pointers that are stored in a ledger, database, append-only log, Merkle tree, cryptographic commitment, or equivalent record store.

The technical problem addressed by this module includes difficult forensic reconstruction of system behavior. The module addresses that problem by enforcing deterministic namespace association, versioned state recording, cryptographic authentication of administrative changes, and evidence-preserving linkage between the received request, selected route, applied rule, resulting state, and recorded audit artifact.

The module may operate in a centralized mode, decentralized mode, or hybrid mode. In a centralized mode, a trusted operator can approve records and compliance updates. In a decentralized mode, validators, consortium members, or authorized nodes may approve activation through consensus or multisignature control. In a hybrid mode, a central rule source may supply compliance packages while ledger nodes execute local transaction functions and preserve evidence locally.

To maintain auditability, the audit and dashboard layer may generate a record including a request identifier, domain identifier, timestamp, prior-state hash, post-state hash, compliance-block identifier, risk-indicator identifier, settlement identifier, user or operator credential, signature, version identifier, and retention pointer. A later audit can reconstruct the route and the reason for each state transition without relying solely on unstructured logs.

Implementation of the audit and dashboard layer may include separate subcomponents for intake, validation, transformation, route selection, state update, cryptographic signing, exception handling, and evidence emission. The subcomponents may execute synchronously in a transaction pipeline or asynchronously by generating a signed work item that is consumed by a subsequent contract, gateway, risk engine, compliance engine, or repository.

In some embodiments, a failure of the audit and dashboard layer does not necessarily invalidate all pending transactions. The system may place affected transactions into escrow, mark them for review, revert a pending instruction where permitted, generate a compensating transaction, or freeze a domain route pending verification. The cause of the recovery action is linked to the same namespace record and audit-history pointer used for the ordinary transaction path.

The audit and dashboard layer may be configured to expose an examiner-readable audit record showing the input, transformation, enforcement rule, and output. Such evidence-oriented configuration makes the module more than a generic business rule executed on a computer because it changes how routing, compliance selection, risk enforcement, and settlement proof are represented and preserved in the distributed computing architecture.

Example operation: when a transaction request invokes the audit dashboard and examiner-visible evidence component, the system verifies that the domain route is active, selects or verifies the relevant parameter set, creates or updates claim-correlated logs and evidence pointers, and emits a signed evidence object that can be referenced by a later compliance review, dispute review, settlement reconciliation, or claim-support analysis.

### 18. Scalability and Hierarchical Partitioning

In one embodiment, the hierarchical namespace partitioning layer is implemented by one or more processors executing instructions stored in non-transitory memory. The hierarchical namespace partitioning layer communicates with other system components through signed application programming interfaces, message queues, smart-contract calls, gateway calls, or policy-enforced middleware. The module may be hosted by a central operator, a consortium service, a cloud cluster, an on-premises server, edge nodes, or a hybrid arrangement of sub-bank nodes.

The hierarchical namespace partitioning layer receives input data including domain identifiers, user or institution identifiers, ledger routes, compliance parameters, risk parameters, collateral parameters, currency support parameters, brand parameters, public-key references, wallet or account references, and audit pointers. The module produces domain layers, inherited parameters, and local overrides that are stored in a ledger, database, append-only log, Merkle tree, cryptographic commitment, or equivalent record store.

The technical problem addressed by this module includes flat identifiers that do not scale across global operations. The module addresses that problem by enforcing deterministic namespace association, versioned state recording, cryptographic authentication of administrative changes, and evidence-preserving linkage between the received request, selected route, applied rule, resulting state, and recorded audit artifact.

The module may operate in a centralized mode, decentralized mode, or hybrid mode. In a centralized mode, a trusted operator can approve records and compliance updates. In a decentralized mode, validators, consortium members, or authorized nodes may approve activation through consensus or multisignature control. In a hybrid mode, a central rule source may supply compliance packages while ledger nodes execute local transaction functions and preserve evidence locally.

To maintain auditability, the hierarchical namespace partitioning layer may generate a record including a request identifier, domain identifier, timestamp, prior-state hash, post-state hash, compliance-block identifier, risk-indicator identifier, settlement identifier, user or operator credential, signature, version identifier, and retention pointer. A later audit can reconstruct the route and the reason for each state transition without relying solely on unstructured logs.

Implementation of the hierarchical namespace partitioning layer may include separate subcomponents for intake, validation, transformation, route selection, state update, cryptographic signing, exception handling, and evidence emission. The subcomponents may execute synchronously in a transaction pipeline or asynchronously by generating a signed work item that is consumed by a subsequent contract, gateway, risk engine, compliance engine, or repository.

In some embodiments, a failure of the hierarchical namespace partitioning layer does not necessarily invalidate all pending transactions. The system may place affected transactions into escrow, mark them for review, revert a pending instruction where permitted, generate a compensating transaction, or freeze a domain route pending verification. The cause of the recovery action is linked to the same namespace record and audit-history pointer used for the ordinary transaction path.

The hierarchical namespace partitioning layer may be configured to expose an examiner-readable audit record showing the input, transformation, enforcement rule, and output. Such evidence-oriented configuration makes the module more than a generic business rule executed on a computer because it changes how routing, compliance selection, risk enforcement, and settlement proof are represented and preserved in the distributed computing architecture.

Example operation: when a transaction request invokes the scalability and hierarchical partitioning component, the system verifies that the domain route is active, selects or verifies the relevant parameter set, creates or updates domain layers, inherited parameters, and local overrides, and emits a signed evidence object that can be referenced by a later compliance review, dispute review, settlement reconciliation, or claim-support analysis.

### Example Transaction Processing Pipeline

A local operator registers a domain identifier corresponding to a sub-bank node. The namespace registry validates the identifier, associates jurisdictional and operational parameters with the identifier, deploys or binds a sub-bank smart contract on a selected ledger, records the mapping, and stores an audit pointer.

A user submits a transaction request using the domain identifier. The transaction request may include a sender domain, recipient domain, wallet or account reference, amount, value type, currency form, device/session evidence, and requested ledger or payment route.

The namespace management module resolves the domain identifier to the sub-bank smart contract and ledger route. If the route is missing, duplicated, revoked, expired, transferred, or disputed, the system denies the request or routes it to review.

The pluggable compliance enforcement module selects a compliance block based on jurisdiction, currency type, transaction type, user tier, risk tier, brand profile, or rule version. The compliance block applies know-your-customer, anti-money-laundering, tax, sanctions, stable-token, money-transmission, reserve, securities, or reporting constraints.

The AI-driven risk control module produces a risk indicator. The indicator may be a score, vector, threshold level, route code, policy code, or structured object, and may be stored with the evidence record.

The gating controller combines the selected compliance block and risk indicator to produce an enforcement directive. If permitted, the transaction invokes the sub-bank contract and cross-ledger gateway. If not permitted, the system freezes, throttles, escrows, limits, reverses where permitted, requires collateral, requires step-up verification, or marks the transaction for review.

The cross-ledger gateway records settlement evidence, including a route identifier, transaction hash, proof hash, Merkle proof, block identifier, confirmation status, timestamp, exchange rate, fee amount, namespace header, compliance header, risk header, and reconciliation state.

If later settlement fails, the bounded recovery controller initiates a recovery action. The system records the cause, recovery scope, time window, affected domain identifier, applied compliance version, and resulting settlement state.

In an external payment-network embodiment, a domain-routed transaction request is resolved to a route object, checked against the selected compliance block and risk directive, and only then translated by an external payment-network adapter into a bank API instruction, payment message, card-network request, wire instruction, real-time payment instruction, or ledger transfer message. The adapter returns an adapter receipt, network reference, failure code, or reconciliation result, and the evidence recorder binds that output to the same namespace, route, compliance, risk, gateway, settlement, and recovery fields used for ledger-based settlement.

In a physical-instrument or queued-validation embodiment, a paper instrument, payment card, biometric card, batch identifier, terminal record, or offline queued event is treated as a transaction request that remains pending until the namespace registry, compliance block, AI risk directive engine, protocol-level gate, and gateway adapter verify route status, replay status, credential status, and settlement availability. Duplicate, expired, mismatched, or replayed events are held, quarantined, or routed to review, and a corresponding evidence update is written.

In a hierarchical namespace embodiment, a parent namespace supplies inherited policy constraints, compliance profile identifiers, gateway policies, or quarantine rules for child namespaces while permitting child-specific route objects, contract interfaces, risk thresholds, or adapter selections. The inherited and child-specific parameters are recorded so that later audit can determine which namespace layer controlled the transaction route.

In a bounded-recovery embodiment, a failure, breach, timeout, proof inconsistency, route-object mismatch, or namespace mismatch causes the system to verify the settlement evidence record, check a recovery window or permitted recovery action set, select a retry, hold, escrow, freeze, compensating transaction, quarantine, or administrative-review action, and append recovery evidence to the evidence record rather than performing an unbounded manual reversal.

### TECHNICAL ADVANTAGES

The disclosed system reduces namespace collision by treating a domain identifier as a deterministic route to a route object and ledger-resident contract interface rather than as passive descriptive metadata.

The disclosed route object reduces duplicate contract instances by binding route status, contract interface identity, compliance profile, gateway policy, and settlement-evidence schema to the resolved domain identifier.

The disclosed versioned compliance-block selection reduces redeployment burden by permitting compliance logic to be updated or pinned without replacing every domain-bound contract instance.

The disclosed AI risk directive improves execution control by converting risk analysis into a machine-readable directive consumed by the protocol-level gate rather than leaving the risk analysis as an advisory report.

The protocol-level gate improves distributed transaction security by preventing signing, ledger submission, cross-ledger bridging, and external payment-network transmission unless compliance and risk conditions satisfy the route-object policy.

The cross-ledger gateway improves interoperability by normalizing heterogeneous ledger confirmations, external payment references, and reconciliation states for later audit.

The settlement evidence record improves auditability by linking the domain identifier, route object, compliance version, risk directive, gateway execution data, settlement state, and recovery state into one auditable record.

The bounded recovery process improves state consistency by limiting recovery actions to defined conditions, defined windows, and evidence-record verification rather than permitting open-ended manual reversal.

The optional value-instrument and collateral-state modules preserve the same routing and evidence architecture for cards, physical instruments, tokens, and collateral-state signals without turning those commercial artifacts into the core invention.

The audit export module improves diligence, licensing, and regulatory review by producing a structured export of route-object history, compliance versions, risk directives, gateway receipts, recovery status, and signature or digest data.

The hierarchical namespace embodiment supports delegated domains and inherited policy constraints while preserving deterministic route-object resolution for each child namespace.

The external payment-network adapter embodiment permits a gated request to be translated into bank API, message, ledger-transfer, or other external network formats while preserving the route and evidence record.

The physical or queued validation embodiment permits paper, card, biometric, or offline queued events to be validated against the same ledger validation interface, replay engine, compliance block, risk directive, and evidence recorder.

The low-energy or node-monitoring embodiment may select a route, node, or adapter using monitored resource-state metadata while maintaining the same gate and settlement evidence architecture.

The disclosed boundary with any upstream identity-root system preserves independent patentable scope because the transaction routing, compliance-risk gating, gateway execution, and settlement-evidence operations do not require a particular upstream credential generator.

### ADDITIONAL EMBODIMENTS AND VARIATIONS

In a permissioned-ledger embodiment, the domain namespace registry is maintained by a consortium service and route-object updates require authenticated operator credentials or multi-party approval before a child namespace, contract interface, compliance profile, gateway policy, or route status becomes active.

In a public-ledger embodiment, route-object commitments, compliance-block identifiers, gateway references, or settlement evidence digests are anchored on a public ledger while private transaction details remain in an off-ledger repository accessible through authorized audit procedures.

In a bank-rail adapter embodiment, a permitted gated request is converted into a bank API instruction, wire-transfer message, real-time payment message, card-network instruction, or clearing instruction, and the returned network reference is stored in the gateway header of the settlement evidence record.

In a card-present or biometric-card embodiment, an instrument code, card identifier, biometric-card status, device signature, or batch identifier is associated with a namespace route and validated by the compliance block and risk directive before settlement is permitted.

In an offline-queue embodiment, a terminal stores a signed pending event until network connectivity is available; the queued event is later checked for nonce, idempotency key, timestamp, device signature, route-object status, compliance result, and risk directive before final ledger or payment-network transmission.

In a privacy-preserving credential embodiment, the compliance block receives a credential reference, proof hash, verification status, or issuer identifier and writes a credential-result identifier to the settlement evidence record without exposing unnecessary personal data to every ledger node.

In a collateral-state embodiment, a collateral record is treated as a route-controlled state object whose valuation status, lien status, oracle reference, escrow state, or permitted recovery action is read by the risk engine or protocol-level gate before the system selects hold, escrow, review, substitution, quarantine, or bounded recovery.

In a policy-inheritance embodiment, a parent namespace supplies compliance, risk, or gateway-policy constraints to child namespaces while allowing child-specific contract endpoints or route-status flags; the evidence record identifies both the inherited policy and the child-specific route data used for the transaction.

In a security-attestation embodiment, registry updates, compliance-block updates, gateway-policy updates, and recovery actions require digital signatures, role-based credentials, secure-element attestations, or hardware-security-module signatures that are preserved in an audit record.

In a resource-aware routing embodiment, node-load, queue-depth, latency, energy-use, gateway-failure, or compromise indicators are treated as optional routing metadata that may cause the gateway to select, avoid, quarantine, or delay a node while preserving the same protocol-level gate and evidence-record architecture.

In an audit-export embodiment, an authorized verifier queries settlement evidence records by namespace, route-object hash, compliance-block version, risk-model version, gateway adapter, settlement state, recovery state, or time window and receives an export package including route-object history, compliance versions, risk directives, gateway receipts, recovery status, and signature or digest data.

In each of the foregoing embodiments, optional value instruments, collateral-state objects, operator-state records, participation-state records, physical instruments, sustainability metrics, external-network adapters, or upstream identity references operate as inputs to the same namespace resolution, compliance-risk gating, gateway execution, settlement evidence, and bounded recovery pipeline rather than as independent business results.

### Detailed Route-Controlled Implementation Scenarios

In a route-object creation scenario, the registry receives a normalized domain identifier, operator credential, requested ledger network, contract-interface pointer, compliance-profile identifier, gateway-policy identifier, and evidence-schema identifier. The registry verifies route status and stores a route object having a domain hash, registry version, active or suspended status, contract interface identifier, and audit-history pointer so that later transaction routing is not performed by an ambiguous account label.

In a duplicate-prevention scenario, a received transaction request or registration request is compared against active, pending, reserved, transferred, revoked, suspended, disputed, and archived route states. When the canonicalized domain identifier conflicts with an existing route object or mismatches a contract interface, the protocol-level gate places the request in hold, quarantine, or review state and the evidence recorder writes the mismatch reason code.

In a compliance-version pinning scenario, the compliance selector reads the compliance profile identifier from the route object and selects a rule package having a version identifier, signature, digest, jurisdiction parameter, transaction-type parameter, and value-type parameter. The selected rule package returns a pass, fail, hold, limit, credential-required, or reporting-required result that is stored with the evidence record rather than being left as an external advisory note.

In a compliance-update scenario, an authorized update interface receives a revised compliance block, verifies its source credential, validates the block in a sandbox against sample route objects and transaction requests, assigns a new version identifier, and makes the updated block available for future transactions while preserving prior settlement evidence records with their originally applied compliance-block versions.

In a risk-directive mapping scenario, a feature vector is generated from transaction amount, value type, namespace history, compliance result, identity or behavioral evidence, device or session data, collateral-state data, prior settlement failures, dispute history, or chargeback history. The risk engine outputs a risk indicator that is mapped to a directive such as approve, deny, hold, throttle, freeze, limit amount, require step-up verification, route to escrow, restricted gateway, or bounded recovery.

In a protocol-gate scenario, the gate receives the selected compliance result and the machine-readable enforcement directive before signing, ledger submission, cross-ledger bridging, payment-network transmission, escrow release, collateral release, or settlement finalization. If the route object is inactive, the compliance result fails, the directive conflicts with the gateway policy, or the route status is quarantined, the gate prevents propagation and writes a gate-output state.

In a ledger-contract interface scenario, the route object identifies a ledger-resident contract interface that can be a smart contract, ledger account, contract endpoint, application binary interface, contract-facing service, or programmable ledger object. The transaction request is bound to that interface only after route-status verification so that a stale, transferred, revoked, or disputed namespace cannot invoke an incorrect contract instance.

In a cross-ledger scenario, a permitted transaction request is routed from a source contract interface through a gateway controller to a public ledger adapter, consortium ledger adapter, external payment-network adapter, bank API adapter, or message adapter. The gateway returns a proof, network reference, failure code, timeout state, reconciliation result, or confirmation status for inclusion in the gateway header of the evidence record.

In a payment-network translation scenario, the external-network adapter translates a gated request into a destination format, including a ledger transfer message, bank API instruction, payment message, card-network authorization message, wire instruction, or real-time payment instruction. The adapter preserves the namespace reference, route-object identifier, gateway-policy identifier, amount or asset field, idempotency key, and result reference so that the evidence record remains machine-verifiable.

In a settlement-evidence scenario, the evidence recorder creates a structured evidence object having a namespace header, route header, compliance header, risk header, gateway header, settlement header, recovery header, timestamp, request hash, prior-state hash, post-state hash, and signature or digest chain. A verifier can reconstruct the route, rule version, risk directive, adapter, settlement state, and recovery state without relying on unstructured log entries.

In a bounded-recovery scenario, the system does not perform open-ended manual reversal. Instead, the bounded recovery controller verifies the evidence record, checks a recovery policy associated with the route object, determines whether a recovery window or action limit applies, and selects retry, hold, escrow, freeze, compensating transaction, dispute marking, quarantine, or administrative review as a bounded machine action.

In a parent-child namespace scenario, a parent domain, region layer, industry layer, institution layer, franchise layer, operator layer, or user layer may supply inherited policy constraints. A child namespace may hold a specific contract interface, route status, or risk parameter. The evidence record identifies the inherited and child-specific route fields that affected a transaction request.

In a delegated-operator scenario, an operator credential or service-level flag is stored as route-associated policy metadata. The compliance block, risk module, or protocol-level gate uses that metadata to determine route status, throttling, suspension, review routing, gateway selection, or evidence generation. The metadata is not required to define revenue sharing or a franchise business model.

In a participation-state scenario, a participation-state record, governance-state record, operator-state record, or service-level record may be read by a contract interface or compliance block to determine permissions, route status, review state, or audit flag. The technical role of the record is to supply machine-readable route-control metadata, not to require a particular dividend, royalty, ownership, or investment arrangement.

In a value-instrument scenario, a physical instrument, payment card, biometric card, electronic account credit, stable-value token, algorithmic token, cryptocurrency asset, non-fungible token, time-based token representation, or behavior-based token representation is represented as an asset-type field in the route object or evidence record and remains subject to the same protocol gate before settlement.

In a queued-card scenario, a card-present terminal or offline device stores a pending transaction attempt with a card identifier, device identifier, batch identifier, timestamp, nonce, or signature. When the event is submitted, the namespace resolver, compliance block, AI risk engine, replay engine, and protocol gate determine whether the event can proceed, must be held, or must be quarantined.

In a replay-validation scenario, the validation engine checks nonce values, idempotency keys, timestamps, device signatures, instrument codes, route-object status, prior settlement evidence, and gateway references. A duplicate or inconsistent event is blocked or routed to review, and the evidence recorder stores the replay result for later dispute analysis.

In a collateral-state scenario, a collateral record may store an asset reference, valuation reference, lien status, oracle reference, custody reference, escrow state, contract endpoint, permitted recovery action, or substitution rule. The risk engine or protocol gate converts collateral status into a machine-readable state such as hold, escrow, threshold review, substitution, quarantine, evidence update, or permitted recovery.

In a trigger-based state-control scenario, a payment failure, valuation feed, compliance breach, settlement timeout, sensor state, oracle value, or external status message may serve as an input to the risk model or compliance block. The trigger changes route control, gateway selection, collateral state, or recovery state through the same evidence-record architecture rather than creating a separate insurance or claims-processing invention.

In a privacy-preserving status scenario, the compliance block may verify a credential reference, proof hash, issuer identifier, verification status, credential expiration state, or account-status result without exposing underlying personal records to every ledger or gateway node. The evidence record stores a proof identifier or verification status rather than unnecessary private data.

In a security-signature scenario, route-object updates, compliance-block updates, gateway-policy updates, administrator actions, and recovery actions may require digital signatures, role-based permissions, secure-element attestations, hardware-security-module signatures, multi-party approval, or policy-container checks. The signature or digest information is linked to the audit-history pointer or evidence record.

In a gateway-failure scenario, the gateway returns a failure code, timeout status, partial-settlement state, missing confirmation, inconsistent proof, or reconciliation mismatch. The evidence recorder stores the gateway state, and the bounded recovery controller uses the route policy to select an allowed machine action rather than leaving failure handling to a separate manual spreadsheet or after-the-fact report.

In a reconciliation scenario, source ledger confirmations, destination ledger confirmations, bank API references, card-network references, clearing references, custody references, or exchange references are normalized into a common gateway execution state. The route object and settlement evidence schema specify which fields are required for the transaction to be marked settled, pending, failed, quarantined, or recoverable.

In an audit-query scenario, an authorized verifier searches by domain identifier, route-object hash, registry version, compliance-block version, risk-model version, gateway adapter, settlement state, recovery state, or time window. The audit interface returns route-object history, compliance versions, risk directives, gateway receipts, recovery status, and signature or digest values.

In an asset-package diligence scenario, the audit export module creates a diligence package containing namespace chain, route-object history, compliance-block versions, risk-directive records, gateway receipts, settlement-state records, recovery records, and digest data.

Such export supports review of the machine architecture and its recorded state transitions without requiring the reviewer to infer operation from informal business reports.

In a domain-transfer scenario, a domain identifier may be transferred from one operator, ledger interface, or contract endpoint to another. The registry stores prior-state hash, post-state hash, transfer credential, timestamp, and registry version so that later transaction requests can be bound only to the active route object and not to a stale mapping.

In a stable-token or redemption scenario, the compliance block may enforce issuance, redemption, reserve, value-type, reporting, or gateway constraints associated with a stable-value representation. The protocol gate prevents minting, burning, redemption, or external settlement if the route object is inactive or if compliance and risk conditions do not satisfy the route policy.

In a multi-currency routing scenario, asset-type fields in the route object distinguish physical instruments, card instruments, electronic account credits, stable-value tokens, algorithmic tokens, cryptocurrencies, non-fungible tokens, time-based token representations, and behavior-based token representations. The gate applies the selected compliance block and risk directive before the selected instrument type is settled.

In a bounded scope scenario, the optional modules described above may be used individually or in combinations, but the claimed technical contribution remains the ordered machine architecture in which a domain identifier resolves to a route object and contract interface, selected compliance and risk outputs control a protocol-level gate, a gateway executes only permitted requests, and an evidence recorder stores settlement and recovery state.

### CONCLUSION

The foregoing description discloses a domain-routed sub-bank computing architecture that solves technical problems arising from ambiguous identifiers, duplicated contract instances, inconsistent ledger routes, redeployment-heavy compliance rules, after-the-fact risk enforcement, weak cross-ledger reconciliation, and non-auditable settlement paths.

The disclosed features may be combined in different ways. Unless a claim expressly requires all described modules, an embodiment may include a subset of modules. Although examples refer to domain identifiers, a namespace key may include any machine-resolvable hierarchical identifier capable of deterministic mapping to a contract interface and ledger route.

Variations, substitutions, and equivalents may be made without departing from the scope of the claimed invention.

### TECHNICAL DEFINITIONS AND DATA STRUCTURES

As used herein, a domain identifier or domain namespace may include a machine-readable namespace string, domain name, subdomain, decentralized namespace label, registry key, rooted domain label, account-domain label, or hierarchical namespace token that is canonicalized into a normalized identifier before route lookup. Canonicalization may include case normalization, separator normalization, removal of unsupported characters, verification of namespace syntax, or generation of a digest corresponding to the normalized identifier.

A domain namespace registry may include a database, ledger record, smart contract, resolver table, append-only registry, cryptographic registry, distributed registry, or hybrid storage service configured to store mappings between canonicalized domain identifiers and route objects. The registry may store active, pending, suspended, revoked, transferred, disputed, reserved, or archived route status values and may expose query, update, revocation, and audit interfaces.

A route object may include a data structure containing at least a domain identifier, domain-identifier hash, registry version, route status, ledger network identifier, contract address, contract interface identifier, compliance profile identifier, risk-model identifier, gateway policy identifier, supported value-form parameter, collateral or recovery parameter, public-key reference, evidence schema identifier, timestamp, signature, or audit-history pointer. The route object provides a deterministic machine route from the namespace to a ledger-resident contract interface.

A ledger-resident contract interface, which may be described in some embodiments as a sub-bank smart contract or sub-bank ledger contract, may include a smart contract, contract endpoint, contract application binary interface, ledger account, programmable ledger object, or contract-facing service associated with a namespace route and configured to receive, validate, hold, reject, settle, or record transaction requests according to compliance and risk-gating state.

A pluggable compliance block may include a modular rules table, executable ruleset, policy object, contract module, validation object, or interpretable compliance package selected based on namespace metadata, jurisdiction metadata, participant status, value type, transaction type, or gateway policy. The compliance block may expose a standard interface that receives a transaction request and mapping metadata and returns a pass state, fail state, hold state, reporting requirement, credential requirement, transaction limit, or reason code.

An AI-driven risk indicator may include a machine-generated score, vector, category, class label, anomaly value, threshold state, route code, policy code, or structured object generated from a feature vector. The feature vector may include transaction data, namespace history, ledger history, identity evidence, behavioral evidence, collateral state, device or session signals, compliance-block output, prior settlement outcomes, chargeback data, dispute data, or administrator input.

An enforcement directive may include a machine-readable control instruction derived from a risk indicator and compliance result. The directive may instruct the system to approve, deny, hold, throttle, freeze, limit amount, require step-up verification, require collateral, route to escrow, route to review, select a restricted gateway, initiate bounded recovery, or generate an alert. The directive may be stored with model version, feature hash, threshold value, reason code, or directive parameter data.

A protocol-level gate may include a processor-executed control component configured to prevent signing, ledger submission, cross-ledger bridging, external payment-network transmission, escrow release, collateral release, or settlement finalization unless a compliance result and an enforcement directive satisfy a gateway policy or route-object policy. The gate may operate before ledger invocation, during gateway routing, before release of escrow, or before final settlement evidence is marked complete.

A cross-ledger gateway may include a software gateway, adapter, bridge, API connector, payment-rail connector, message router, settlement adapter, or network interface configured to transmit a permitted transaction between a source ledger, destination ledger, contract interface, bank rail, payment network, card network, custody service, or external settlement system and to return a proof, transaction reference, failure indication, or reconciliation status.

A settlement evidence record may include an append-only or ledger-stored record containing at least a namespace header, route-object identifier, contract-interface identifier, compliance-block identifier and version, compliance result, risk-indicator identifier, risk model version, enforcement directive, gateway adapter identifier, source or destination transaction reference, external payment reference, timestamp, signature, digest, prior-state hash, post-state hash, settlement state, or recovery state. The evidence record links the route, compliance, risk, gateway, and settlement states in a machine-verifiable record.

A bounded recovery operation may include a deterministic recovery procedure triggered by failed settlement, proof inconsistency, compliance violation, risk threshold breach, timeout, route-object mismatch, namespace mismatch, or ledger-state conflict. The recovery operation may verify the settlement evidence record, evaluate a recovery policy, and execute a limited retry, hold, freeze, escrow, reversal where permitted, compensating transaction, dispute marking, quarantine, or administrative review.

### EXAMPLE ALGORITHMS

Example namespace registration algorithm. The system receives a domain identifier, owner credential, ledger network identifier, and contract-interface identifier; canonicalizes the domain identifier; verifies the owner credential; checks that the canonicalized identifier is not already active, reserved, suspended, or revoked; creates a route object including the canonicalized identifier, registry version, ledger network identifier, contract endpoint, compliance profile, gateway policy, route status, and evidence schema; writes the route object into the namespace registry; and emits a registry update event or audit record.

Example transaction-processing algorithm. The system receives a transaction request associated with a domain identifier; canonicalizes the domain identifier; resolves the canonicalized identifier to a route object; verifies that the route object is active; loads the ledger-resident contract interface; selects a versioned compliance block; generates a compliance result; generates a risk indicator and enforcement directive; applies a protocol-level gate; routes a permitted request to the contract interface or cross-ledger gateway; and records a settlement evidence record.

Example compliance-selection algorithm. The system queries a compliance repository using one or more of a compliance profile identifier, jurisdiction, transaction type, value type, participant credential, gateway policy, and route status; selects a valid compliance block version; verifies a block signature, digest, or version identifier; executes the selected block against request data and route-object metadata; and returns a structured compliance result including pass/fail state, constraint data, reason codes, or reporting requirements.

Example AI risk-directive algorithm. The system builds a feature vector from transaction amount, value type, namespace history, compliance output, identity or behavioral evidence, device signal, collateral state, prior settlement outcomes, or dispute data; applies a risk model or rule engine; generates a score, vector, threshold state, or class label; maps the risk output to an enforcement directive; and stores a feature hash, model version, risk indicator, directive, and reason code in an audit or evidence record.

Example protocol-gating algorithm. If the compliance result fails, the gate blocks the request and records denial evidence. If the risk directive indicates hold, the gate prevents ledger submission and places the request into a hold or review state. If the directive indicates limit or restricted gateway, the gate modifies routing parameters according to a gateway policy. If compliance and risk states permit the request, the gate authorizes signing, contract invocation, gateway routing, or payment-network transmission.

Example cross-ledger settlement algorithm. The gateway receives a gated request, route object, contract endpoint, value type, and destination network; generates an idempotency key or nonce; invokes a source ledger, escrow interface, bridge interface, payment adapter, or destination contract; obtains a transaction reference, proof, or failure code; reconciles source and destination states; and returns a gateway execution result for inclusion in the settlement evidence record.

Example settlement-evidence algorithm. The system creates an evidence object including domain hash, registry version, route-object hash, contract-interface identifier, compliance-block identifier and version, compliance result, risk-model identifier and version, risk indicator, enforcement directive, gateway adapter identifier, source and destination transaction references, external payment reference where applicable, timestamp, request hash, settlement state, and signature. The evidence object may be stored in an append-only log, on-ledger event, database, receipt object, or cryptographic commitment.

Example bounded-recovery algorithm. Upon timeout, proof inconsistency, compliance breach, risk breach, or route mismatch, the system verifies the evidence object, determines whether a recovery window and amount or state limit applies, identifies an allowed recovery action, executes retry, hold, freeze, escrow, reversal where permitted, compensating transaction, dispute marking, quarantine, or administrative review, and updates the evidence record with recovery state and recovery proof.

### RELATED-APPLICATION BOUNDARY AND CLAIM SUPPORT

In some embodiments, a transaction request may include an upstream credential, proof bundle, identity-root record, behavioral certification record, signed receipt, endpoint status, or validated-event reference. The present disclosure does not require any particular upstream identity or behavioral certification system. The present disclosure concerns downstream machine routing of a namespace-associated transaction request to a ledger-resident contract interface, selection of compliance and risk-control objects, enforcement of a routing directive, gateway execution, settlement evidence generation, and bounded recovery.

The disclosed domain-routed transaction layer may operate independently of, or in combination with, an upstream BEI identity-root or behavioral certification layer. Where an upstream proof or credential is available, it may be used as an input to compliance or risk evaluation. However, the claimed routing, gating, settlement, and evidence operations do not require generation of an upstream tokenized identity asset, signed accounting receipt, proof bundle, TransferKey, derived TransKey, or context-specific access object unless expressly recited in a claim.

Support for the domain namespace registry, route object, and deterministic mapping appears at least in paragraphs [0008]-[0009], [0034]-[0042], and [0311]-[0313]. Support for the ledger-resident contract interface and contract binding appears at least in paragraphs [0009],[0036]-[0046], and [0314]. Support for pluggable compliance block selection and update appears at least in paragraphs [0012]-[0013], [0051]-[0055], and [0315].

Support for the AI-driven risk indicator, enforcement directive, and protocol-level gate appears at least in paragraphs [0011], [0047]-[0060], and [0316]-[0318]. Support for cross-ledger gateway routing appears at least in paragraphs [0010], [0061]-[0065], and [0319]. Support for the settlement evidence record and bounded recovery appears at least in paragraphs [0047]-[0069] and [0319]-[0323].

The foregoing technical definitions, data structures, and algorithms are provided to clarify implementation of the originally disclosed domain-based sub-bank contract, AI risk, pluggable compliance, cross-ledger settlement, collateral, brand-governance, and co-ownership concepts. The examples are not intended to limit the claims unless expressly recited. Variations, substitutions, and equivalents may be made without departing from the scope of the claimed invention.

### Support-Consistent Integration of Domain-Financial Security, Routing, and Settlement Details

### Domain-Root and Route-Object Clarification

The disclosed domain-routed sub-bank computing architecture may be implemented using a root domain, parent domain, second-level domain, subdomain, decentralized namespace label, account-domain label, or other machine-resolvable namespace key as the domain identifier. The use of a particular illustrative domain name is not required. The relevant technical function is that the identifier is canonicalized and resolved through a registry entry or route object that binds the identifier to a ledger-resident contract interface, compliance profile, gateway policy, and settlement-evidence schema.

In certain embodiments, the route object may include a canonical domain string, a normalized identifier hash, a registry-version value, a parent-namespace reference, a child-namespace reference, a ledger network identifier, a contract endpoint, a contract interface identifier, a compliance-profile identifier, a risk-model identifier, a gateway-policy identifier, a route-status flag, an evidence-schema identifier, and an audit-history pointer. These fields clarify the originally disclosed domain-to-contract mapping by specifying machine-readable data that enables deterministic transaction routing rather than merely naming a financial account.

A parent namespace may define inherited route parameters for child namespaces. For example, a country, industry, organization, franchise, branch, user, card, or asset namespace may inherit a compliance profile or gateway policy from a parent namespace while retaining a child-specific contract endpoint or risk parameter. Such inheritance is used to reduce duplicated configuration state, prevent conflicting contract instances, and provide a stable audit trail when a transaction request is processed through multiple domain layers.

Where a parent or root domain functions as a namespace authority anchor, the anchor may hold a registry key, route policy, revocation list, compliance-version pointer, or gateway-permission record. The anchor need not be a legally chartered bank; it is a machine-controlled namespace authority that determines whether a sub-bank contract interface remains active, suspended, transferred, quarantined, or revoked for routing purposes.

### External Network, Financial Messaging, and Gateway Adapters

The cross-ledger gateway may communicate not only with blockchain ledgers but also with external payment networks, bank application programming interfaces, card-network gateways, clearing networks, wire-transfer systems, real-time payment rails, financial messaging gateways, or other settlement adapters. Such adapters translate a permitted transaction request into the message format, signature format, account reference, ledger call, or clearing instruction required by the destination network while preserving the route-object and evidence-record linkage.

In one embodiment, a gateway adapter receives a permitted transaction request and a route object, forms an outbound gateway message containing an idempotency key, source network identifier, destination network identifier, contract endpoint, value type, amount or asset quantity, participant namespace references, nonce, and gateway-policy identifier, and receives a result containing one or more settlement references. The gateway adapter records whether the transaction was submitted, accepted, rejected, timed out, partially settled, or fully settled.

The gateway adapter may normalize heterogeneous confirmation data into a common gateway execution state. For example, a destination ledger may return a block identifier and transaction hash, while an external payment rail may return a message reference or clearing confirmation. The evidence recorder stores these different settlement references in a common evidence-record structure so that a verifier can reconstruct the domain, compliance, risk, routing, and settlement state without relying on an off-system manual record.

When a transaction is routed to an external payment network, the protocol-level gate may prevent signing, submission, bridging, or external payment-network transmission unless the selected compliance block and the AI-generated enforcement directive satisfy the route object gateway policy. This machine-enforced gate distinguishes the system from a conventional post-transaction audit system or a user-facing financial dashboard.

### Secure Channels, Identity Verification, and Privacy-Preserving Compliance

The system may use cryptographic signatures, public-key certificates, hardware security modules, secure elements, biometric-card interfaces, multifactor authentication, verifiable credentials, zero-knowledge proof interfaces, or privacy-preserving credential checks to support identity status, account status, authorization status, or compliance status. These security features are implementation mechanisms for the originally disclosed KYC, AML, biometric-card, and AI risk-control functions, and do not require a particular identity-provider architecture.

In one embodiment, a transaction request includes a credential reference, proof reference, device-state reference, or account-status reference. The compliance block verifies whether the referenced credential satisfies the compliance profile associated with the route object. The route object and evidence record store identifiers or hashes of the credential result rather than unnecessary personal data, thereby supporting compliance while reducing data exposure in the ledger or gateway path.

The compliance module may be implemented as a versioned policy object, rules table, executable rule module, smart-contract hook, or service endpoint having a standardized input-output interface. The input may include transaction type, asset type, jurisdiction parameter, participant credential state, route-object metadata, amount, device information, and prior settlement status. The output may include pass, fail, hold, require additional credential, limit amount, require review, freeze, escrow, or restricted-gateway status.

Where privacy-preserving computation is used, the system may verify a participant status, balance state, sanction-screening result, or credit-state result without exposing the underlying personal record to every network node. The evidence record may store a proof identifier, proof hash, credential issuer identifier, or verification status rather than the underlying private data.

### AI Risk Directive and Protocol-Level Enforcement

The AI-driven risk control module may generate a risk vector, score, classification, anomaly flag, confidence value, or risk state from a feature vector. The feature vector may include namespace history, transaction history, device signal, velocity metrics, external credit or reputation reference, collateral state, compliance-block result, gateway history, settlement failure history, and participant credential state.

The risk output is converted into a machine-readable enforcement directive rather than remaining as a passive advisory score. The enforcement directive may instruct the protocol-level gate to approve, deny, hold, throttle, freeze, cap amount, require collateral, require additional credential, select restricted gateway, route to review, quarantine route, initiate bounded recovery, or generate an alert. The directive therefore changes how the distributed system processes the transaction request.

The risk model may be updated or retrained using aggregated settlement evidence, rejected transaction records, confirmed fraud records, collateral outcomes, compliance outcomes, gateway failure rates, or namespace-specific transaction patterns. A risk-model identifier and version may be stored with the evidence record so that later audit can determine which risk model was applied at the time of transaction processing.

Where federated learning, secure multi-party computation, or privacy-preserving model training is used, multiple institutions, nodes, or sub-bank operators may contribute model updates without centralizing raw private data. This arrangement is optional and supports the originally disclosed AI risk-control and compliance framework by providing a privacy-preserving way to improve fraud detection, credit scoring, and anomaly detection models.

### Physical Instruments, Cards, Offline Queues, and Replay Validation

The multi-currency management module may support physical currency instruments, payment cards, biometric cards, secure-card identifiers, electronic account credits, stable-value tokens, non-fungible tokens, account balances, vouchers, or other value representations. A physical or card-based instrument may be associated with a domain identifier, card identifier, batch identifier, device identifier, or contract endpoint and may be validated against the route object and compliance profile before value transfer.

In certain embodiments, a device or terminal operating under weak network conditions may queue signed transaction instructions or card-present authorization data. When connectivity is restored, the queued instructions may be submitted to the namespace registry, compliance block, AI risk engine, and settlement gateway for validation before final settlement. Replay validation may check nonce values, idempotency keys, timestamps, device signatures, route-object status, and prior settlement evidence to detect duplicate or forged instructions.

The offline or queued instruction embodiment does not require settlement while disconnected. Rather, it preserves a transaction request or authorization attempt until the protocol-level gate can verify route status, compliance status, risk state, and gateway availability. Final settlement remains controlled by the route object, compliance block, risk directive, and settlement-evidence pipeline.

If a physical card, biometric card, or printed instrument is duplicated or appears in inconsistent transaction evidence, the AI risk module or compliance block may generate a freeze, hold, review, or quarantine directive. The evidence recorder stores the relevant card identifier, device identifier, route-object hash, compliance result, risk directive, and settlement status for later audit and bounded recovery.

### Collateral, Insurance-like Triggers, and Risk-Directed Asset Controls

The collateral and liquidation module may register real estate, vehicles, receivables, domain-based assets, digital tokens, securities-like records where permitted, franchise rights, or other collateral references. The module may store ownership status, lien status, valuation reference, oracle reference, escrow state, contract endpoint, and permitted recovery actions. These details clarify the originally disclosed collateral and automated liquidation functions without requiring a new business model.

In some embodiments, external data sources, sensor records, valuation feeds, market feeds, payment-failure events, or compliance-breach events may operate as risk or collateral triggers. Such triggers may cause the risk engine to adjust an enforcement directive, require additional collateral, route to escrow, block settlement, initiate liquidation instruction, or generate a recovery record. The system need not implement a separate insurance product to use external objective data as a technical trigger for transaction gating or recovery.

Automated payout or claim-like behavior, where used, may be treated as a conditional smart-contract settlement controlled by the same route object, compliance block, risk directive, gateway adapter, and evidence record. This preserves the technical focus on transaction execution and settlement control rather than adding an independent insurance invention.

Collateral or trigger records are preferably stored as references, hashes, oracle identifiers, status fields, or contract-interface references in the route object or evidence record. The system therefore preserves auditable state without requiring every external asset record or private valuation record to be copied into a public ledger.

### Low-Energy, Green-Node, and Resource Monitoring Embodiments

The system may include a low-energy node monitoring subsystem as an optional technical implementation of network sustainability and operational risk control. The subsystem may collect node-load information, power-consumption estimates, carbon-intensity indicators, hardware utilization, transaction queue depth, or gateway latency and may provide this data to the AI risk or routing module.

Where a route object or sub-bank contract can be executed by more than one node segment, the gateway or routing module may select a lower-load node, lower-risk node, lower-latency node, or lower-energy node when consistent with the compliance profile and settlement policy. This optional routing optimization provides a technical implementation of the originally disclosed sustainability and energy-monitoring concept without making environmental reward distribution a core claim requirement.

The low-energy monitoring subsystem may generate a node-state record containing node identifier, consensus segment identifier, load metric, energy metric, queue metric, route status, and timestamp. The evidence recorder may store a reference to the selected node-state record when node condition affects a transaction route, settlement route, or bounded-recovery route.

The system may also quarantine or avoid a node segment when node-state evidence indicates abnormal energy use, network congestion, repeated gateway failure, or suspected compromise. Such node selection and quarantine functions are implemented as technical routing and safety functions rather than as a separate green mining system.

### Governance, Audit Interface, and Controlled Update Boundaries

The system may include an administrator interface, regulator interface, governance interface, or multi-authority update interface for approving compliance-block updates, route-object status changes, gateway-policy updates, emergency freezes, or bounded-recovery actions. The interface may require signatures, role-based permissions, multi-party approvals, or policy-container checks before an update becomes active.

An approved update may be written as a new registry version, compliance-block version, gateway-policy version, or risk-threshold version. The versioned update does not require redeploying every sub-bank contract if the contract interface calls the current active compliance block or route policy through a registry reference. This supports the technical advantage of dynamic policy update while preserving ledger-resident contract state.

An audit interface may allow an authorized verifier to query settlement evidence records by domain identifier, route-object hash, contract-interface identifier, compliance-block version, risk-model version, gateway adapter, settlement state, recovery status, or time window. The query may return the evidence fields, cryptographic digest, signatures, and linked settlement references required to reconstruct the machine decision path.

The governance or audit interface is not required to distribute revenue, decide franchise terms, or manage business relationships. It is a technical control surface for route status, compliance updates, risk thresholds, gateway rules, evidence verification, and recovery authorization.

### Examples Preserving Original Scope Without Importing New Independent Inventions

Example 1: A domain identifier corresponding to a local payment node is registered in the namespace registry. The registry creates a route object that includes a contract endpoint, compliance-profile identifier, gateway-policy identifier, and evidence-schema identifier. A transaction request using the domain identifier is canonicalized, resolved to the route object, checked against the selected compliance block, risk scored, and submitted to a gateway only if the resulting enforcement directive permits execution.

Example 2: A biometric card associated with a user namespace submits a transaction request. The system verifies a credential reference and card identifier, selects a compliance block based on jurisdiction and transaction type, generates a risk directive using card history and settlement history, and records evidence linking the card identifier, route object, compliance result, risk directive, and settlement state.

Example 3: A cross-network transfer is initiated from a domain-routed ledger contract to an external payment network. The gateway adapter translates the permitted request into the destination network format and receives a confirmation or failure reference. The evidence recorder stores a route-object hash, compliance-block version, risk-model version, gateway adapter identifier, external reference, and settlement state.

Example 4: A gateway timeout occurs after the source ledger reports a pending debit. The bounded-recovery module verifies the evidence record, checks a recovery policy associated with the route object, and executes a hold, retry, compensating instruction, reversal where permitted, or quarantine action. The recovery result is appended to the evidence record.

Example 5: A parent namespace updates a compliance profile for a class of child namespaces. The update interface validates the new compliance block, assigns a version identifier, activates it for future transaction requests, and preserves prior evidence records with their originally applied compliance versions. This allows later transactions to use updated compliance logic without altering historical settlement evidence.

### Support-Preservation Statement for Related-Domain Disclosures

The above embodiments are intended to clarify the originally disclosed domain-based sub-bank contract, AI risk control, pluggable compliance, multi-currency, cross-ledger gateway, physical/digital instrument, collateral, brand-governance, co-ownership, and sustainability concepts. They do not require the use of a particular root domain, token standard, banking charter, insurance product, cryptographic algorithm, governance organization, or external payment network unless expressly recited in a claim.

Related domain-financial implementations may include additional features such as post-quantum cryptographic channels, federated risk-model training, external financial messaging adapters, dynamic token issuance, green-node monitoring, domain passport identifiers, DAO voting, media or medical services, or broad asset-tokenization marketplaces. Such features may be used only to the extent they implement or clarify the modules originally disclosed herein, and are not imported as required limitations of the present claims unless expressly recited.

Where an implementation uses stronger cryptographic channels, privacy-preserving proofs, low-energy node selection, multi-card routing, or external messaging adapters, those features operate as security, routing, compliance, or settlement-support mechanisms for the same domain-routed transaction pipeline. The inventive focus remains the ordered machine architecture that resolves a domain identifier to a route object and contract interface, applies compliance and AI risk gating, routes permitted transactions through a gateway, and records settlement evidence.

The claims may therefore be practiced by a centralized, decentralized, or hybrid system; by a permissioned ledger, public ledger, consortium ledger, database-backed settlement engine, external payment rail, or combination; and with or without optional collateral, brand, co-ownership, sustainability, insurance-like trigger, or governance embodiments.

### ORIGINAL-SUPPORT ALIGNMENT FOR AMENDED CLAIM ELEMENTS

Domain identifier and namespace registry: supported by the originally disclosed domain names, registered domains, sub-domains, and domain-to-contract mapping module that links each registered domain to a sub-bank contract on a distributed ledger.

Route object and contract interface: supported by the originally disclosed sub-bank contract, namespace authority anchor, cross-ledger gateway, ledger route, and domain-based contract spawning or binding concepts.

Pluggable compliance block: supported by the originally disclosed regional or industry-specific KYC and AML rules, tax obligations, watchlists, and remote regulatory or operator updates.

AI risk indicator and enforcement directive: supported by the originally disclosed AI risk control module that aggregates transaction logs, KYC information, credit data, brand or loyalty metrics, collateral values, and other data to produce credit scoring, fraud alerts, freeze directives, limit directives, collateral requirements, and review actions.

Protocol-level gate: supported by the originally disclosed ability of sub-bank contracts and AI risk control to freeze, limit, prevent, or condition transactions before or during execution.

Cross-ledger gateway and external payment adapters: supported by the originally disclosed cross-ledger gateway handling exchanges between sub-banks or external networks and by the disclosed multi-currency settlement environment.

Settlement evidence record: supported by the originally disclosed distributed ledger records, transaction logs, compliance metrics, collateral actions, participation-state, governance-state, or audit records, and gateway settlement states, now technically organized into a linked evidence structure.

Multi-currency and physical instruments: supported by the originally disclosed physical banknotes, cards, biometric cards, digital tokens, stablecoins, algorithmic tokens, NFTs, and account credits.

Collateral and liquidation: supported by the originally disclosed pledging of real estate, vehicles, intangible assets, digital tokens, valuation monitoring, default triggers, and automated liquidation.

Brand-franchise and participation records: supported by the originally disclosed brand-franchise management, brand compliance, operator-policy amounts, uniform marketing or user-interface standards, co-ownership tokens, governance status, and service-level records.

Sustainability and low-energy operations: supported by the originally disclosed sustainability module, energy monitoring, carbon-footprint optimization, and low-energy distributed operation.

Bounded recovery: supported by the originally disclosed freeze, limit, collateral, liquidation, default, revocation, suspicious activity, and settlement control functions, now expressed as constrained machine recovery actions associated with evidence records.

For avoidance of doubt, examples referring to financial messaging adapters, privacy-preserving credential verification, low-energy node selection, queued transaction validation, or trigger-based collateral controls are optional implementation examples of the disclosed domain-routed transaction pipeline. They do not convert the present application into a separate post-quantum, insurance, DAO, marketplace, or green-mining invention.

### ADDITIONAL NON-LIMITING IMPLEMENTATION NOTES FOR ROUTE-CONTROLLED ASSET STATES

When optional asset, card, collateral, brand, or participation records are used, each such record is treated as a route-controlled state object rather than as a separate business objective.

The state object may include an asset identifier, namespace reference, owner or operator credential reference, contract-interface reference, value-type field, compliance status, risk status, gateway status, and evidence-record pointer. A transaction involving the state object remains subject to the same namespace resolution, compliance selection, risk directive, protocol gate, and settlement-evidence pipeline as any other transaction request.

A participation or co-ownership record, where present, may be stored as a ledger state associated with a domain identifier, sub-bank contract interface, contribution index, governance status, or service-level flag. The technical function of the record is to provide a machine-readable input to a contract interface or compliance rule; the claimed transaction-routing system does not require a particular service-level, operator-policy, franchise, or investment arrangement. This separation permits optional business metadata to be processed without changing the core technical route-control architecture.

A brand or operator record, where present, may include operator identifier, user-interface parameter, brand-standard status, suspension flag, operator-policy-logic pointer, or service-level parameter. The compliance block or risk engine may use such fields to permit, limit, suspend, or route transaction requests. The record is therefore implemented as policy metadata in the route object or associated registry rather than as a standalone franchise business model.

A dynamic value, reward, or issuance parameter, where present, may be controlled by the same protocol-level gate and evidence-record structure. For example, a contract interface may refuse a mint, burn, reward, card issuance, collateral release, or participation update unless the route object is active, the selected compliance block passes, the risk directive permits the action, and the evidence recorder can bind the resulting state transition to the applied compliance and risk versions.

These implementation notes preserve a clear boundary between the technical invention and optional commercial embodiments. The technical invention is the machine architecture that determines whether a namespace-associated transaction or state transition may be routed, executed, recorded, recovered, or quarantined. Optional financial, card, collateral, brand, sustainability, or participation examples supply use cases for that architecture without broadening the required claim scope beyond the originally disclosed modules.

### FINAL TECHNICAL SUPPORT SUMMARY

In view of the foregoing disclosure, each claimed module is described in terms of its input data, processing logic, output state, and relationship to the route object, protocol-level gate, gateway execution path, and settlement evidence record. The domain namespace registry receives a domain identifier and outputs a route object; the compliance block selector receives route-object metadata and outputs a pinned compliance result; the AI risk directive engine receives transaction and evidence features and outputs a machine-readable enforcement directive; the protocol-level gate receives the compliance result and enforcement directive and outputs a permitted, held, blocked, throttled, escrow-routed, or review-routed state; the gateway receives a permitted request and outputs gateway execution data; and the settlement evidence recorder receives the foregoing states and outputs an auditable record.

The embodiments described herein therefore support the claims as a machine-implemented distributed transaction routing and settlement-control architecture. Optional value instruments, collateral-state objects, namespace policy metadata, card or physical instrument interfaces, low-energy routing, audit export, and upstream identity references are treated as route-controlled states or external inputs that operate through the same namespace resolution, compliance-risk gating, gateway routing, evidence recording, and bounded recovery pipeline. The scope of protection is defined by the claims.

Each claim element is intended to be read in relation to the corresponding data structure and flow described above. The domain namespace registry provides the lookup key and route object. The selected compliance block provides a versioned policy result. The AI risk directive engine converts model or rule output into a machine-readable directive. The protocol-level gate consumes those outputs before propagation to a ledger, gateway, or payment network. The evidence recorder then preserves the operative state for later verification.

The disclosure further supports operation across centralized, decentralized, and hybrid deployments. In each deployment, the same route-object fields, compliance-block versioning, risk-directive schema, gateway state, evidence headers, and bounded recovery states can be maintained by one or more processors, ledger nodes, service endpoints, hardware-secured devices, or network adapters. The architecture is therefore not limited to a particular blockchain, payment rail, token standard, bank interface, domain registry, or identity provider.

Optional commercial, operational, collateral, participation, card, physical-instrument, sustainability, or audit-export embodiments are included only as examples of route-controlled states processed through the same technical pipeline. Such embodiments do not replace the core technical contribution: deterministic namespace resolution, route-object binding, versioned compliance-risk gating, cross-ledger or external-network execution, settlement evidence recording, and bounded recovery based on the recorded evidence state.

What is claimed is:

1. A domain-routed distributed transaction computing system for operating a plurality of domain-routed ledger contract instances, the system comprising:
one or more processors, one or more memories storing executable instructions, and one or more network interfaces:
a domain namespace registry configured to store a plurality of mappings between respective domain identifiers and respective route objects, each route object identifying at least a ledger route, a ledger-resident contract interface, a compliance profile identifier, a gateway policy identifier, a route status, and a settlement-evidence schema identifier:
a namespace resolution module configured to canonicalize a domain identifier included in a transaction request and to deterministically resolve the canonicalized domain identifier against the domain namespace registry to retrieve a corresponding route object:
a contract binding module configured to bind the transaction request to the ledger-resident contract interface identified by the corresponding route object and to verify that the corresponding route object has an active route status before transaction execution;
a pluggable compliance enforcement module configured to select, based on compliance metadata of the corresponding route object, a selected compliance block from a plurality of versioned compliance blocks and to execute the selected compliance block against the transaction request before ledger submission;
an AI-driven risk control module configured to generate a risk indicator for the transaction request from at least ledger transaction history and identity or behavioral evidence and to convert the risk indicator into a machine-readable enforcement directive:
a protocol-level gate configured to prevent signing. ledger submission, cross-ledger bridging, or external payment-network transmission of the transaction request unless a compliance result from the selected compliance block and the machine-readable enforcement directive satisfy the gateway policy of the corresponding route object;
a cross-ledger gateway configured, when the protocol-level gate permits the transaction request. to route the transaction request between the ledger-resident contract interface and at least one external ledger or payment network; and
an evidence recorder configured to generate and store a settlement evidence record linking the domain identifier, the corresponding route object, the selected compliance block, the risk indicator the machine-readable enforcement directive, gateway execution data. and a settlement state.

2. The system of claim 1, wherein the domain identifier comprises a hierarchical domain namespace including at least one of a country or region layer, an industry layer, an institution layer, an operator layer, a user laver. a delegated sub-namespace laver, or a domain-bound ledger contract layer.

3. The system of claim 1, wherein the corresponding route object includes at least a domain-identifier hash, a registry version, a contract address, a contract interface identifier, a ledger network identifier, a jurisdiction parameter, the compliance profile identifier, the gateway policy identifier, the route status, and the settlement-evidence schema identifier.

4. The system of claim 1, wherein the namespace resolution module is further configured to detect whether the domain identifier is unmapped, duplicated, transferred, suspended, revoked. disputed, reserved, or mismatched with the ledger-resident contract interface before the protocol-level gate permits the transaction request.

5. The system of claim 1, wherein the selected compliance block includes at least one of a know-your-customer rule set, an anti-money-laundering rule set, a sanctions screening rule set, a tax reporting rule set, a stable-token issuance or redemption rule set, an asset-transfer constraint, or a money-transmission constraint.

6. The system of claim 1, wherein the pluggable compliance enforcement module includes an update interface configured to receive an updated compliance block, validate the updated compliance block, assign a version identifier to the updated compliance block, and apply the updated compliance block to future transaction requests while preserving an existing domain-to-contract mapping and ledger-resident contract state.

7. The system of claim 1, wherein the machine-readable enforcement directive comprises at least one of approve, deny, hold, throttle, freeze, limit amount, require step-up verification, require collateral-state verification, route to escrow, route to review, use a restricted gateway, or initiate bounded recovery.

8. The system of claim 1, wherein the AI-driven risk control module generates a feature vector including at least one of a namespace history, a transaction-history value, a compliance-block result, an identity-status value, a behavioral-evidence value, a collateral-status value, a device or session signal, or a prior settlement-outcome value.

9. The system of claim 1. wherein the cross-ledger gateway includes a lock or escrow interface, a proof generator, a settlement controller, a reconciliation module, and an audit log module configured to maintain state consistency across heterogeneous ledger environments or external payment-network adapters.

10. The system of claim 1, wherein the settlement evidence record includes at least a namespace header identifying the domain identifier, a route header identifying the corresponding route object, a compliance header identifying a compliance-block version, a risk header identifying the risk indicator or enforcement directive, a gateway header identifying an adapter or proof, and a settlement header identifying a ledger transaction, payment-network reference, proof, or reconciliation state.

11. The system of claim 1. further comprising a value-instrument routing module configured to associate at least two of physical currency instruments, payment cards, biometric cards, electronic account credits, stable-value digital tokens, algorithmic tokens, cryptocurrencies, non-fungible tokens, time-based token representations, or behavior-based token representations with asset-type fields in the corresponding route object and to submit such value instruments to the protocol-level gate before settlement.

12. The system of claim 1. further comprising a collateral-state module configured to register collateral-state records, monitor collateral value or borrower status, and generate a machine-readable collateral-state signal that causes the protocol-level gate to select at least one of escrow routing, hold routing, threshold review, collateral substitution, evidence update, quarantine, or a permitted recovery action.

13. The system of claim 1, further comprising a namespace policy-metadata module configured to store operator parameters, brand-standard parameters, participation-state records, governance-state records, or service-level records as route-controlled metadata associated with the domain identifier, wherein the route-controlled metadata is converted into at least one of a route-status flag, gateway-policy parameter, throttling parameter, operator-permission parameter, suspension flag, or audit flag used by the protocol-level gate.

14. A computer-implemented method for operating a domain-routed ledger network, the method comprising:
receiving, by one or more processors, a transaction request associated with a domain identifier:
canonicalizing the domain identifier to produce a canonicalized domain identifier:
resolving the canonicalized domain identifier against a domain namespace registry to retrieve a route object identifying a ledger route, a ledger-resident contract interface, a compliance profile identifier, a gateway policy identifier, and a route status;
verifying that the route object has an active route status;
selecting, based on compliance metadata in the route object, a selected compliance block from a plurality of versioned compliance blocks;
executing the selected compliance block against the transaction request to generate a compliance result;
generating, by an AI-driven risk control module, a risk indicator for the transaction request based on ledger transaction history and identity or behavioral evidence;
converting the risk indicator into a machine-readable enforcement directive;
applying a protocol-level gate based on the compliance result and the machine-readable enforcement directive before signing, ledger submission, cross-ledger bridging, or external payment-network transmission;
when the protocol-level gate permits the transaction request, invoking the ledger-resident contract interface or routing the transaction request through a cross-ledger gateway; and
recording a settlement evidence record linking the domain identifier, the route object, the selected compliance block, the risk indicator, the machine-readable enforcement directive, gateway execution data, and a settlement state.

15. The method of claim 14, further comprising receiving an updated compliance block through an update interface, validating the updated compliance block, assigning a version identifier to the updated compliance block, and applying the updated compliance block to future transaction requests while preserving an existing domain-to-contract mapping and ledger-resident contract state.

16. The method of claim 14, wherein applying the protocol-level gate comprises preventing execution of the transaction request when the compliance result fails, when the risk indicator exceeds a threshold, when the route object is inactive, or when the route object fails to satisfy the gateway policy.

17. The method of claim 14, further comprising routing the transaction request through the cross-ledger gateway to an external payment network or a second distributed ledger having a different address format, contract model, or consensus mechanism.

18. The method of claim 14, further comprising, responsive to a failed settlement, proof inconsistency, risk threshold breach, compliance violation, route-object mismatch, or namespace mismatch, initiating a bounded recovery action comprising escrow, freeze, retry, hold, reversal where permitted, compensating transaction, dispute marking, quarantine, or administrative review, and updating the settlement evidence record to identify the bounded recovery action.

19. A non-transitory computer-readable medium storing instructions that, when executed by one or more processors of a distributed computing system, cause the distributed computing system to perform operations comprising:
maintaining a domain namespace registry comprising mappings between domain identifiers and route objects, each route object identifying at least a ledger route, a ledger-resident contract interface, a compliance profile identifier, a gateway policy identifier, a route status, and a settlement-evidence schema identifier;
receiving a transaction request associated with a domain identifier;
canonicalizing the domain identifier and resolving the canonicalized domain identifier to a corresponding route object:
verifying that the corresponding route object has an active route status and binding the transaction request to the ledger-resident contract interface identified by the corresponding route object;
selecting a versioned compliance block based on compliance metadata associated with the corresponding route object;
generating a risk indicator for the transaction request using an AI-driven risk control module:
generating a machine-readable enforcement directive from the risk indicator;
applying a protocol-level gate before signing, ledger submission, cross-ledger bridging, or external payment-network transmission based on the selected versioned compliance block and the machine-readable enforcement directive; and
recording an auditable evidence record linking the domain identifier, the corresponding route object, the selected versioned compliance block, the risk indicator, the machine-readable enforcement directive, gateway execution data, and a settlement state.

20. The non-transitory computer-readable medium of claim 19, wherein the operations further comprise storing the auditable evidence record in an append-only log or ledger-anchored record and using the auditable evidence record to verify a bounded recovery action after a failed settlement, compliance violation, risk breach, or route-object mismatch.
